(19) United States
(12) Patent Application Publication
(10) Pub. No.: US 2025/0340578 A1
(43) Pub. Date: Nov. 6, 2025

(54) NEW SUBSTITUTED PHOSPHITE TRANSITION METAL COMPOUNDS

(71) Applicant: Momentive Performance Materials GmbH, Leverkusen (DE)

(72) Inventors: Oliver Safarowsky, Köln (DE); Nina Winkler, Ratingen (DE); Sabine Wilhelm, Leverkusen (DE); Andrea Ruppenthal, Leverkusen (DE); Maik Dresler, Monheim (DE)

(21) Appl. No.: 18/868,208

(22) PCT Filed: May 25, 2023
(86) PCT No.: PCT/EP2023/064044

§ 371 Date: Nov. 22, 2024

(30) Foreign Application Priority Data
May 25, 2022 (EP) 22175337.9

(51) Int. Cl. C07F 9/6574; C07F 15/00; C08G 77/20

(52) U.S. Cl. CPC C07F 9/65746; C07F 15/0086; C08G 77/20

(57) ABSTRACT

The present invention relates to a transition metal compound, comprising at least one phosphite compound of the formula

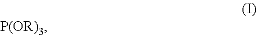

wherein
R represents an organic group, and wherein at least one group R is represented by the formula (II)

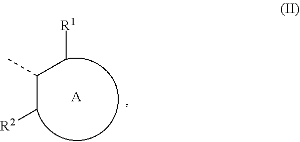

wherein
the ring denoted by A represents an aromatic or heteroaromatic group, which may have one or more further substituents apart from R¹ and R²,
the dotted line represents a single bond to the oxygen atom of the phosphite compound of formula (I),
R¹ and R² each represent substituents in the ortho-position of said aromatic or heteroaromatic group relative to the oxygen atom of the phosphite compound of formula (I), and wherein said substituents R¹ and R² are each independently selected from the group consisting of an optionally substituted aliphatic group and an optionally substituted aliphatic bridging group that forms a condensed ring system with another atom of the aromatic or heteroaromatic group corresponding to the ring denoted by A, and wherein at least two groups R are different from each other.

The invention further relates to the use of the transition metal compound of formula (I) as a curing catalyst for curable polyorganosiloxane compositions and/or silane compositions, curable polyorganosiloxane compositions and/or silane compositions comprising one or more transition metal compounds of the formula (I), the use thereof for the manufacture of shaped articles, and a process for the manufacture of said curable polyorganosiloxane compositions.

### FIELD OF THE INVENTION

This invention relates to new substituted phosphite transition metal compounds, to the use of the transition metal compounds as a curing catalyst for curable polyorganosiloxane compositions and/or silane compositions, to curable polyorganosiloxane compositions and/or silane compositions comprising one or more transition metal compounds as cited above, to the use of one or more phosphites as cited above for the manufacture of curable polyorganosiloxane and/or silane compositions, to curable polyorganosiloxane and/or silane compositions, comprising one or more phosphites as cited above, to cured polyorganosiloxane and/or silane compositions obtained by curing the curable polyorganosiloxane and/or silane compositions as cited before, to the use of the curable polyorganosiloxane compositions and/or silane compositions as cited before for the manufacture of shaped formed articles, extruded articles, coatings, and sealants, and to a process for the manufacture of the curable polyorganosiloxane compositions as cited before.

### BACKGROUND/STATE OF THE ART

Platinum-(0)-vinylsiloxane complexes such as the divinyltetramethyl-disiloxane complex (Karstedt's catalyst) or tetravinyltetramethyl-cyclotetrasiloxane can catalyse the hydrosilylation reaction at very high reaction rates. Therefore, these catalysts are currently used for crosslinking, curing or vulcanization of silicone rubber having alkenyl and SiH-groups by hydrosilylation between 20-200° C. However, this reaction at room temperature according to Arrhenius Law sometimes shortens the pot-life or bath-life time in an unacceptable manner (1-10 min at 25° C.).

It is well known from prior art disclosures that the high reaction rates of platinum catalysts can be slowed down by inhibitors, such as esters, e.g., maleates and fumarates, ketones, sulfoxides, phosphines, phosphites, nitrogen- or sulphur containing derivatives, hydroperoxides as well as acetylene derivatives such as alkinoles. If one describes the effect of such inhibitors in terms of Arrhenius Law one can observe in generally a shifted line in a diagram showing 1/k (k=reaction constant [s⁻¹]) over 1/T (° K) as x-axis, i.e., if the pot-life is extended one can observe at the same time a decreased reaction rate at higher temperatures.

Some prior art documents attempt to decouple the effect of pot-life and cure rate at higher temperature. For example, U.S. Pat. No. 3,188,300 discloses specific aliphatic, cyclo-aliphatic and aromatic phosphites in order to anticipate premature gelling at 20-30° C. EP 948565 A1 discloses siloxane compositions comprising substituted and aromatic phosphites which shows a different relation between cure rate at 140° C. and pot-life at room temperature. US 2006/0135689 (Fehn) discloses siloxane compositions comprising olefin-nitrogen containing-ligand-platinum complexes, which should have enlarged pot-life at room temperature and high reaction rates at higher temperatures.

US 2006/0128881 A1 and US 2004/0116561 A1 disclose hydrosilylation curing polyorganosiloxane compositions comprising phosphites but fail to disclose phosphites having aryloxy groups substituted by further alkenyl and/or aryl groups. Moreover, these documents are not concerned with the technical object of decoupling the effect of pot-life and cure rate at higher temperature in hydrosilylation curing polyorganosiloxane compositions.

WO2010009755 (A1) discloses polyorganosiloxane and/or silane hydrosilylation-curing compositions comprising specific phosphites and transition metal compounds comprising at least one of the specific compounds. The phosphites referred to therein bear three identical aromatic groups either substituted by at least one aromatic group or by at least one alkenyl group.

U.S. Pat. No. 3,188,300 A1 and U.S. Pat. No. 5,380,812 also disclose the use of phosphites as inhibitors in hydrosilylation curing silicone compositions. Among the possible substituents there are also mentioned monocycloaliphatic groups, i.e. cyclohexyl and trisphenylphosphite. The present inventors have found however, that the use of tris(cyclohexyl)-phosphite or tris(phenyl)-phosphite reveals an unacceptable low curing rate at high temperatures, although the pot-life or storage stability, respectively, is acceptable.

JP2007 009041 A in Examples 1-5 discloses a curable composition containing an organic compound containing at least two carbon-carbon double bonds that react with SiH groups, a compound containing at least two SiH groups within a molecule, and the presence of a platinum vinyl siloxane complex and a phosphite compound, from which a hydrosilylation catalyst may be formed. Further, JP2007 009041A discloses a generic structure of phosphites being a constituent of curable compositions comprising an organic compound containing at least two carbon-carbon double bonds that react with SiH groups, a compound containing at least two SiH groups within a molecule and a hydrosilylation catalyst. Transition metal catalysts based on the phosphites of JP2007 009041A are not comprised by the scope of the present invention, and JP2007 009041A is remote from the present invention insofar as it is preferred therein that the compound containing the carbon-carbon double bonds does not contain siloxane units, while the present invention requires the constituent having at least two alkenyl groups to be a polyorganosiloxane.

In the “Journal of Organometallic Chemistry”, vol. 799, p. 201-207, Grice et al. disclose structures of Pt(II) metallacycles obtained via cyclometallation by C—H activation starting from a Pt complex comprising a phosphite with three identical aryl substituents. As one of the arylalkyl substituents of a phosphite ligands in the complexes disclosed therein is a divalent member of the metallacycle, the structures disclosed are different from the transition metal compounds of the present invention, in which the phosphites bear three univalent organic residues on the O atoms of the phosphite. In “Polymer”, vol. 33, no. 1, p. 161-165, Jongsma et al. disclose the coordination of an aryl phosphite to a rhodium central metal atom to form a rhodium hydroformylation catalyst. Said catalysts are formed in the context of investigating polymer-bound rhodium hydroformylation catalysts, which is remote from the field of the present invention.

In the “Journal of Molecular Catalysis A Chemical”, vol. 259, no. 1-2, p. 267-274, Gavrilov et al. disclose rhodium, palladium and platinum complexes prepared from iminoaryl phosphites containing a ferrocenyl or a cymantrenyl group. The publication is directed at the application of palladium complexes as catalysts for asymmetric allylic substitution reactions, which is remote from the field of the present invention.

In DE 223770, which is directed at the development of catalysts for the hydrocyanation of olefins, a tri-(2,5-xylyl)-phosphite nickel complex is disclosed. There is no disclosure of transition metal compounds falling within the scope of the present invention or any phosphite compounds comprising a 2,6-substituted aryl group in said document.

The present invention attempts to provide hydrosilylation curing polyorganosiloxane compositions, in particular, ‘one-part’ and ‘two-part’ hydrosilylation curing polyorganosiloxane compositions that have a high pot-life, i.e. storage stability, and at the same time have high curing rates at elevated temperatures, which property is not affected upon long-term storage. The present inventors have found that surprisingly specific phosphites having substituted aromatic groups with specific residues are suitable to solve these problems and can provide better dispersibility due to lower melting points.

### SUMMARY OF THE INVENTION

Accordingly, the present invention is related to a transition metal compound, comprising at least one phosphite compound of the formula

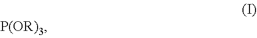

wherein
R represents an organic group, and wherein at least one group R is represented by the formula (II)

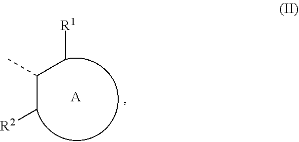

wherein
the ring denoted by A represents an aromatic or heteroaromatic group, which may have one or more further substituents apart from R¹ and R²,
the dotted line represents a single bond to the oxygen atom of the phosphite compound of formula (I),
R¹ and R² each represent substituents in the ortho-position of said aromatic or heteroaromatic group relative to the oxygen atom of the phosphite compound of formula (I), and
wherein said substituents R¹ and R² are each independently selected from the group consisting of an optionally substituted aliphatic group, in particular optionally substituted alkyl groups and optionally substituted alkenyl groups, and an optionally substituted aliphatic bridging group that forms a condensed ring system with another atom of the aromatic or heteroaromatic group corresponding to the ring denoted by A, alkoxy groups, alkoxycarbonyl groups and Si-organic groups, and wherein at least two groups R are different from each other,
with the proviso that the transition metal compound is different from
   Pt complexes comprising the phosphite of the formula

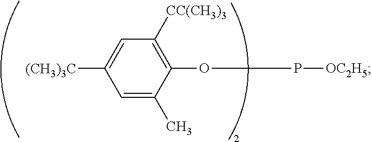

the Rh complexes

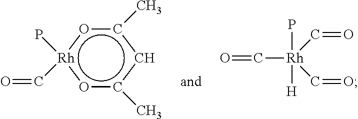

wherein the ligand P represents the structure and

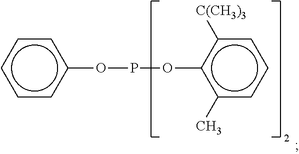

and

Rh, Pd and Pt complexes comprising phosphites of the general formula

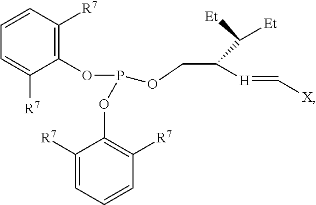

wherein R⁷ is methyl and X is a ferrocenyl group,
or R⁷ is methyl and X is a cymantrenyl group,
or R⁷ is isopropyl and X is a ferrocenyl group.

The invention further relates to the use of the transition metal compound comprising a phosphite compound of the formula (I) as a curing catalyst for curable polyorganosiloxane compositions and/or silane compositions, to curable polyorganosiloxane compositions and/or silane compositions comprising one or more of such transition metal compounds comprising a phosphite of the formula (I), and to the use of one or more phosphites of the formula (I) for the manufacture of curable polyorganosiloxane and/or silane compositions, to curable polyorganosiloxane and/or silane compositions comprising one or more phosphites of the formula (I) as well as two-part curable polyorganosiloxane and/or silane compositions, to cured polyorganosiloxane and/or silane compositions obtained by curing the curable polyorganosiloxane and/or silane compositions as mentioned before, and to the use of the curable polyorganosiloxane compositions and/or silane compositions as mentioned before for the manufacture of shaped formed articles, extruded articles, coatings, and sealants, as well as to a process for the manufacture of the curable polyorganosiloxane compositions as mentioned before.

### DETAILED DESCRIPTION OF THE INVENTION

In a first aspect, the invention relates to a transition metal compound comprising at least one phosphite compound.

Specifically, the invention is directed at a transition metal compound comprising at least one phosphite compound of the formula

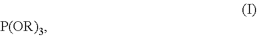

wherein
R represents an organic group, and wherein at least one group R is represented by the formula (II)
wherein

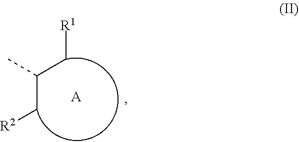

the ring denoted by A represents an aromatic or heteroaromatic group, which may have one or more further substituents apart from R¹ and R²,
the dotted line represents a single bond to the oxygen atom of the phosphite compound of formula (I),
R¹ and R² each represent substituents in the ortho-position of said aromatic or heteroaromatic group relative to the oxygen atom of the phosphite compound of formula (I), and
wherein said substituents R¹ and R² are each independently selected from the group consisting of an optionally substituted aliphatic group, in particular optionally substituted alkyl groups and optionally substituted alkenyl groups, and an optionally substituted aliphatic bridging group that forms a condensed ring system with another atom of the aromatic or heteroaromatic group corresponding to the ring denoted by A, alkoxy groups, alkoxycarbonyl groups and Si-organic groups, and wherein at least two groups R are different from each other.

For the transition metal compound comprising at least one phosphite compound, there is the proviso that the compound is different from
Pt complexes comprising the phosphite of the formula

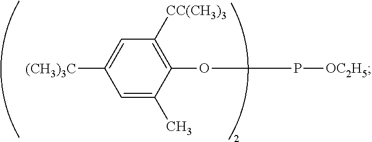

the Rh complexes

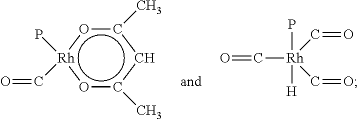

wherein the ligand P represents the structure

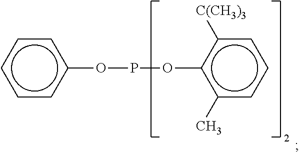

and
Rh, Pd and Pt complexes comprising phosphites of the general formula

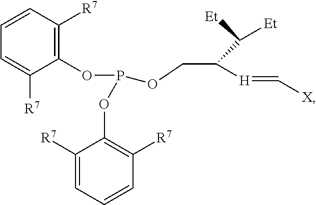

wherein R⁷ is methyl and X is a ferrocenyl group,
or R⁷ is methyl and X is a cymantrenyl group,
or R⁷ is isopropyl and X is a ferrocenyl group.

According to the invention, each compound comprising at least one atom or ion of an element in the d-block of the periodic table, including the f-block lanthanide and actinide series, is considered a transition metal compound.

The transition metal in such transition metal compounds is preferably selected from group consisting of nickel, ruthenium, rhodium, palladium, osmium, iridium, and platinum, with platinum being the most preferred transition metal.

Although it is possible to isolate the transition metal compounds of the invention comprising the specific phosphite ligands of the formula (I), in the practice of hydrosilylation curing polyorganosiloxane systems, often certain common transition metal compounds are added together with the phosphites to the polyorganosiloxanes without separate formation of the transition metal phosphite complex compounds, or alternatively certain transition metal compounds are reacted with the phosphites so to say in situ, the reaction product being added to the hydrosilylation curing polyorganosiloxane systems.

So from a technical point of view the isolation of the transition metal phosphite complex compounds is not required normally and it suffices to determine the influence of the addition of the phosphites on the pot-life or storage stability and the curing rates at higher temperatures without identifying exactly the catalytical active transition metal species.

Nevertheless, one can prepare and isolate the underlying transition metal compounds of the phosphites of the invention by commonly known ligand exchange reactions. For example, the well-known Karstedt catalyst can be reacted with the phosphites of the formula (I) of the present invention to give the transition metal compounds in accordance with the present invention: The synthesis follows a pathway in that, by example, the well-known divinyltetramethyldisiloxane (‘DVTMDS’)-bridged binuclear platinum complex (Karstedt's catalyst) can be cleaved by any nucleophile (e.g. phosphite), giving a mononuclear platinum complexes:

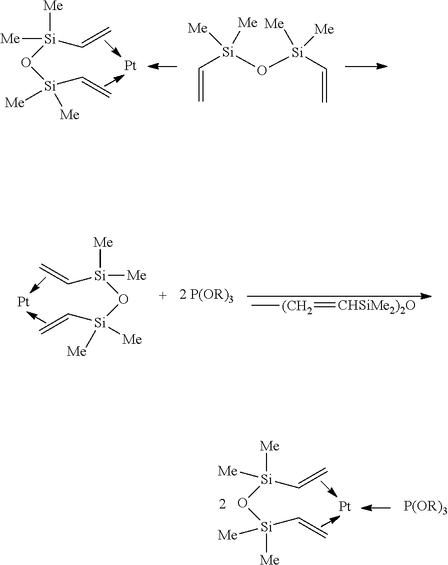

The transition metal compounds according to the invention comprise at least one phosphite compound of the formula

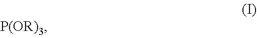

wherein R is an organic group.

Accordingly, the phosphite compounds of the invention are organophosphites, which may be considered esters of an unobserved tautomer of phosphorous acid H₃PO₃.

According to the invention, an organic group is any organic substituent group, regardless of functional type, having one free valence at a carbon atom. The term organyl group may be used interchangeably.

According to the invention, the groups R other than groups R having the formula (II) in the phosphites of the formula (I) are preferably selected from optionally substituted aromatic groups and optionally substituted C1-C12 alkyl groups selected from linear, branched or cyclic alkyl groups, even more preferably optionally substituted C1-C6 alkyl groups.

Therein, the aromatic groups and C1-C12 alkyl groups selected from linear, branched or cyclic alkyl groups constituting the group or groups R other than groups R having the formula (II) in the phosphites of the formula (I) may be substituted with alkoxy groups, alkoxycarbonyl groups, halide group, nitro groups, cyano groups or Si-organic groups, and the aromatic groups may also be substituted with linear, branched or cyclic C1-C12 alkyl groups.

In the phosphite compound of the formula (I), at least one group R is represented by the formula (II)

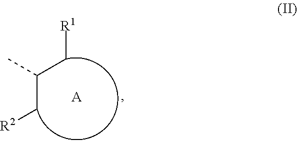

wherein the ring denoted A represents an aromatic or heteroaromatic group, preferably two groups R in formula (I) are represented by the formula (II).

Aromatic groups according to the invention are hydrocarbon groups comprising at least one cyclically conjugated moiety with a stability significantly greater than that of a hypothetical localized structure which may bear substituents other than C and H, for example halide or hydroxyl groups, preferred aromatic groups according to the invention are phenyl, benzyl, xylyl, tri-tert-butylated phenyl, di-tert-butyl phenyl, di-tert-butyl methyl phenyl, tert-butyl di-methyl phenyl, and naphthyl groups.

According to the invention, heteroaromatic groups are heterocyclic groups formally derived from aryl groups by replacement of one or more methine and/or vinylene groups by trivalent or divalent heteroatoms, such as for example S, O or N, in such way that the continuous x-electron system characteristic of aromatic systems is maintained and a significant stabilization is observed, wherein the groups may be optionally substituted with other groups than H and C, for example halide or amino groups. Preferred heterocyclic groups are furyl, thienyl, pyrrolyl, imidazolyl, pyridyl, triazolyl, isochinolyl and chinolyl groups. The aromatic groups and heteroaromatic groups represented by the formula (II) may bear linear, branched or cyclic C1-C12 alkyl groups alkoxy groups, alkoxycarbonyl groups, halide group, nitro groups, cyano groups or Si-organic groups as substituents.

The dotted line in the structure of the formula (II) represents a single bond to the oxygen atom of the phosphite compound of formula (I), which is positioned in an ortho position to each of the groups R¹ and R² in formula (II).

As the groups R in general, the groups of the formula (II) are organic groups with one free valence, by which the structure is bonded to one of the oxygen atoms of the phosphite compound. The groups R do not have an additional free valence or complexation site by which a group R can be bonded to the transition metal atom of the complex or to another ligand of the transition metal compound.

R¹ and R² in the structure of the formula (II) thus each represent substituents in the ortho-position of said aromatic or heteroaromatic group relative to the oxygen atom of the phosphite compound of formula (I), and the groups R¹ and R² in formula (II) are each independently selected from the group consisting of an optionally substituted aliphatic group, in particular optionally substituted alkyl groups and optionally substituted alkenyl groups, an optionally substituted aliphatic bridging group that forms a condensed ring system with another atom of the aromatic or heteroaromatic group corresponding to the ring denoted by A, alkoxy groups, alkoxycarbonyl groups, and Si-organic groups. An aliphatic group constituting R¹ or R², in particular an alkyl group, alkenyl group or aliphatic bridging group as mentioned above, may be substituted with alkoxide groups, alkoxycarbonyl groups, halide group, nitro groups, cyano groups or Si-organic groups.

Alkoxy groups constituting R¹ or R² according to the invention are understood as alkoxide groups linked to the ring A via the oxygen atom, and C1-C12 alkoxy groups are preferred. More preferred, R¹ and R² may be selected from methoxy, ethoxy, n-propoxy, n-butoxy, n-pentoxy, n-hexoxy, n-heptoxy, n-octoxy, n-nonoxy, n-decoxy, iso-propoxy, iso-butoxy, isoamyloxy, cyclopentoxy and cyclohexoxy groups.

Alkoxycarbonyl groups according to the invention are understood as the functional group of an ester, wherein R¹ and R² being selected from the group of alkoxycarbonyls consist of a carbonyl group attached to the ring A which also bears an alkoxide group. Preferably, R¹ and R² may be selected from methoxycarbonyl, ethoxycarbonyl, n-propoxycarbonyl, n-butoxycarbonyl, n-pentoxycarbonyl, n-hexoxycarbonyl, n-heptoxycarbonyl, n-octoxycarbonyl, n-nonoxycarbonyl, n-decoxycarbonyl, iso-propoxycarbonyl, iso-butoxycarbonyl, isoamyloxycarbonyl, cyclopentoxycarbonyl and cyclohexoxycarbonyl groups,

The term Si-organic groups according to the invention comprises alkyl groups bearing one or more Si-based functional groups, such as trialkylsilyl, trialkoxysilyl groups and polyorganosilane groups, carbosilane and carbosiloxane groups, and Si-based functional groups which are bonded to another moiety, for example the ring A, via a silicon atom, such as silyl groups, in particular trialkyl silyl groups, trialkoxysilyl groups, and also Si-based functional groups bonded to another moiety, for example the ring A, via an oxygen atom, in particular siloxy groups.

Examples of siloxy groups are linear or branched oligo- and polysiloxy groups with 1 to 5000 siloxy units selected from dimethylsiloxy units, phenylmethylsiloxy units, diphenyl siloxy units, methylsiloxy units, phenyl siloxy units or SiO_{4/2} units bearing hydroxyl, trimethyl silyl, dimethyl silyl or vinyl end groups. Preferably, the Si-organic groups are selected from trialkylsilyl groups and trialkylsiloxy groups, wherein the alkyl groups are C1-C6 alkyl groups, or from siloxy groups having up to 12 siloxy units, wherein the organic residues are preferably methyl groups, most preferably siloxy groups comprising a D2, D3, D4, D5 or D6 siloxane-based moiety.

Preferably, the groups R¹ and R² in the structure formula (II) are independently selected from C1-C20 linear, branched or cyclic alkyl groups, preferably methyl, ethyl, n-propyl, iso-propyl, cyclopropyl, n-butyl, iso-butyl, sec-butyl, tert-butyl, cyclobutyl, n-pentyl, iso-pentyl, neopentyl, cyclopentyl, n-hexyl, cyclohexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl or n-eicosyl groups, more preferably the groups are independently selected from methyl, ethyl, isopropyl and tert-butyl, most preferably from methyl and tert-butyl groups.

Also preferably, the groups R¹ and R² in the structure formula (II) are independently selected from alkyl groups bearing one or more trialkylsilyl, or trialkoxysilyl groups or Si-based functional groups which are bonded to the ring A via a silicon atom, in particular trialkyl silyl groups, and trialkoxysilyl groups, or Si-based functional groups bonded to the ring A via an oxygen atom, in particular siloxy groups.

It is within the scope of the invention that one of the substituents R¹ and R² is selected from an optionally substituted aliphatic group, while the other substituent is selected from a Si-organic group, an alkoxy group or an alkoxycarbonyl group.

The optional one or more further substituents of the ring A in formula (II) apart from R¹ and R² may be independently selected from any organic group, wherein preferred organic groups are optionally substituted alkyl groups, optionally substituted alkenyl groups, alkoxy groups as defined above and alkoxycarbonyl groups as defined above, halide group, nitro groups, cyano groups, or Si-organic group as defined above.

The alkyl groups and alkenyl groups constituting optional further substituents of the ring A may be substituted with alkoxy groups, alkoxycarbonyl groups, halide group, nitro groups, cyano groups or Si-organic groups. Preferably, further substituents of the ring A in formula (II) apart from R¹ and R² are selected from C1-C12 alkyl substituents, more preferably from methyl, ethyl, iso-propyl and tert-butyl groups, and most preferably from methyl and tert-butyl groups.

According to the definition of the phosphite of the formula (I) and of the groups R having the formula (II), the phosphite may comprise up to six different ortho-substituents R¹ and R² per phosphite compound. Preferably, one of the groups R of the phosphite of the formula (I) is a C1-C12 alkyl group, in particular a methyl, ethyl group or iso-propyl group, and two of the groups R in the formula (I) are represented by the formula (II), wherein the rings A are phenyl groups, each with one or two of the groups R¹ and R² being selected from tert-butyl substituents.

According to the invention, at least two of the groups R of the phosphite compound of the formula (I) comprised by the transition metal compound are different from each other. Preferably, one of the groups R is a C1-C12 alkyl group and the two further R groups are aryl groups, more preferably the two further R groups are both represented by the formula (II), wherein the rings denoted by A are phenyl groups each bearing the groups R¹ and R² and no or one further substituent, most preferably one of the groups R is a C1-C12 alkyl group and the other two groups R groups are both represented by the formula (II), wherein the rings denoted by A are phenyl groups bearing R¹ and R² groups independently selected from methyl and tert-butyl groups, and most preferably said phenyl groups in addition to the groups R¹ and R² independently selected from methyl and tert-butyl groups bear one further substituent selected from methyl and tert-butyl groups or no further substituent.

It is particularly preferred that one group R of the phosphite of the formula (I) is a methyl, ethyl or isopropyl group and the other two R groups in formula (I) are groups R represented by formula (II) which are identical phenyl groups bearing substituents selected from methyl, ethyl and tert-butyl groups as groups R¹, R² and further substituents, if present.

The transition metal compound of the invention is different from
Pt complexes comprising the phosphite of the formula

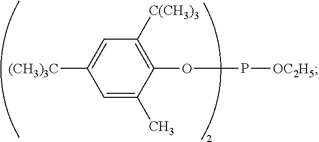

the Rh complexes of the formulas

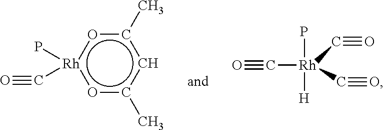

wherein the ligand P represents the structure

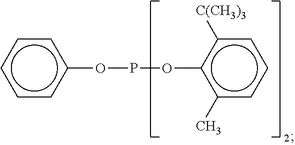

Rh, Pd and Pt complexes comprising phosphites of the formula

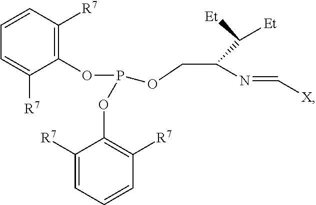

wherein R⁷ is methyl and X is a ferrocenyl group,
or R⁷ is methyl and X is a cymantrenyl group,
or R⁷ is isopropyl and X is a ferrocenyl group; and
the Ni complex of the formula

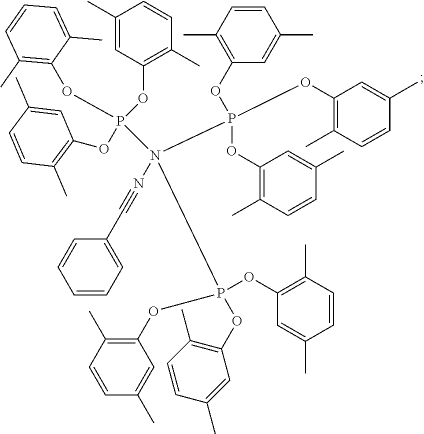

and preferably the transition metal compound is different from
Pt complexes comprising the phosphite of the formula

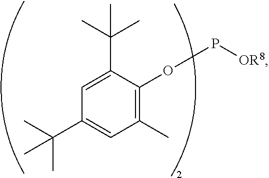

wherein R⁸ is a monovalent organic group having 1 to 5 carbon atoms;
and/or the transition metal compound is preferably different from
transition metal complexes comprising the ligand of the structural formula

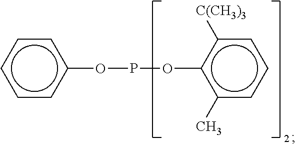

and/or the transition metal compound is preferably different from
transition metal complexes comprising a ligand of the structural formula

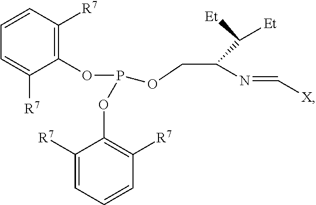

wherein R⁷ is methyl and X is a ferrocenyl group,
or R⁷ is methyl and X is a cymantrenyl group,
or R⁷ is isopropyl and X is a ferrocenyl group;
and/or the transition metal compound is preferably different from
transition metal complexes comprising a ligand of the structural formula

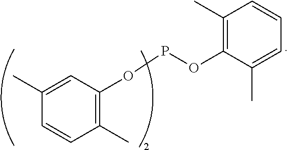

In an embodiment according to the invention, the transition metal compound of the invention comprises at least one phosphite having the formula (III):

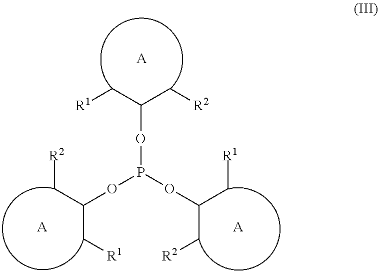

wherein at least two of the groups of the formula (II):

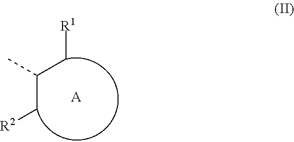

are different groups.

According to this embodiment, it is preferred that two of the groups R having the formula (II) are identical, while the third group R having the formula (II) is different from the two identical groups R having the formula (II).

It is further preferred that all groups R having the structure of the formula (II) are based on phenyl groups, i.e. the ring A in formula (II) represents a phenyl ring, each bearing two or three substituents including the mandatory substituents R¹ and R².

It is even further preferred according to this embodiment that the substituents R¹, R² and, if present, a third substituent having the structures of the formula (II) are each independently selected from methyl, ethyl, isopropyl and tert-butyl groups, most preferably from methyl and tert-butyl groups.

Even further preferred, one or more of the groups R having the structure of the formula (II) in the phosphite having the formula (III) are di- or tri-tert-butylated phenyl groups, more preferably two or more of the groups R having the structure of the formula (II) in the phosphite having the formula (III) are di- or tri-tert-butylated phenyl groups.

If one or more of the groups R having the structure of the formula (II) in the phosphite having the formula (III) are di- or tri-tert-butylated, it is also preferred that the substituents R¹, R² and, if present, further substituents on the ring A of one or two further groups R having the structure of formula (II) are methyl groups.

In another embodiment according to the invention, the transition metal compound according to the invention comprises at least one phosphite compound of the formula (I), wherein in formula (I) at least one group R is an organic group different from the group of formula (II). The group R or groups R in the phosphite of the formula (I) different from an organic group represented by the formula (II) is either selected from unsubstituted aromatic or heteroaromatic groups, aromatic or heteroaromatic groups having no or only one substituent in ortho position to the R group's bond to the oxygen atom, or from aliphatic groups, in particular from C1-C28 alkyl groups. Preferably, the phosphite compound of the formula (I) contains one group R different from the structure of formula (II), and two groups R represented by the formula (II), which may be the same or different.

According to this embodiment, it is preferred that the phosphite compound contains one group different from the structure of formula (II), and more preferred this group R different from the structure of formula (II) is selected from C1-C28 alkyl groups, more preferred from C1-C12 alkyl groups, even further preferred from C1-C6 alkyl groups, even more preferred from methyl, ethyl, n-propyl, iso-propyl, cyclopropyl, n-butyl, iso-butyl, sec-butyl, tert-butyl, cyclobutyl, n-pentyl, iso-pentyl, neopentyl, cyclopentyl, hexyl or cyclohexyl groups, most preferably from methyl and ethyl groups. In addition, the two groups R represented by the formula (II) of the phosphite compound of the formula (I) according to this embodiment may be the same or different.

According to this embodiment, it is preferred that in the phosphite compound of the formula (I) all groups R represented by formula (II) are based on phenyl groups, i.e. the ring A is a phenyl ring, and each of the rings A bears two or three substituents including the mandatory substituents R¹ and R². It is further preferred according to this embodiment that the substituents R¹, R² and, if present, the third substituent each are independently selected from methyl, ethyl, isopropyl and tert-butyl groups, most preferably from methyl and tert-butyl groups.

Even further preferred, in the phosphite compound of the formula (I) the groups R having the structure of formula (II) are di- or tri-tert-butylated phenyl groups, more preferably two of the groups R in the phosphite compound of the formula (I) have the structure of formula (II) and are di- or tri-tert-butylated phenyl groups. If one or more of the groups R having the structure of formula (II) are di- or tri-tert-butylated, it is also preferred that one of the further groups or the further group R in the phosphite compound of formula (I) is a C1-C6 n-alkyl group, most preferably a methyl or ethyl group.

In still another embodiment according to the invention, the transition metal compound according to the invention comprises at least one phosphite selected from the group consisting of the formulae (IV) or (V):

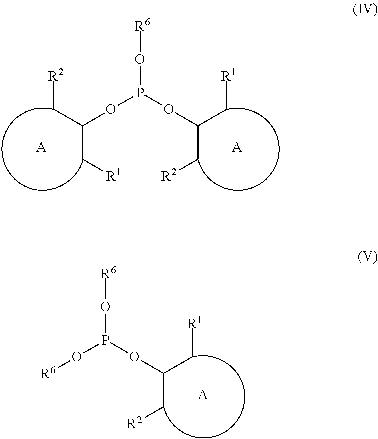

wherein in formula (IV) the groups of the formula (II):

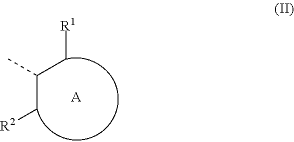

are the same or different groups, and preferably are the same groups, and
are in both formulae (IV) or (V) as defined above, and wherein the groups R⁶ in formula (V) are the same or different groups, and preferably the groups R⁶ are the same groups, and the groups R⁶ are in both formulae (IV) or (V) selected from organic groups different from those of formula (II), and are preferably selected from optionally substituted aliphatic groups, such as 10 optionally substituted alkyl or optionally substituted cycloalkyl groups. Such aliphatic groups constituting R⁶, for example alkyl groups or cycloalkyl groups, may be substituted with alkoxy groups, alkoxycarbonyl groups, halide group, nitro groups, cyano groups or Si-organic groups. Preferably, the group or groups R⁶ in formulae (IV) or (V) is/are selected from C1-C28 alkyl groups, more preferred from C1-C12 alkyl groups, even further preferred from C1-C6 alkyl groups, even more preferred from methyl, ethyl, n-propyl, iso-propyl, cyclopropyl n-butyl, iso-butyl, sec-butyl, tert-butyl, cyclobutyl, n-pentyl, iso-pentyl, neopentyl, cyclopentyl, hexyl or cyclohexyl groups, most preferably from methyl, ethyl, n-propyl or iso-propyl groups.

The group or groups R having the formula (II) in formulae (IV) or (V) are preferably selected from substituted phenyl groups, i.e. the ring A represents a phenyl group, wherein R¹, R² and, if present, further substituents each are independently selected from methyl, ethyl, isopropyl and tert-butyl groups, most preferably from methyl and tert-butyl groups, and even further preferred, one or more of the groups R having the structure of formula (II) in formulae (IV) or (V) are di- or tri-tert-butylated phenyl groups, more preferably two or more of the groups R having the structure of formula (II) are di- or tri-tert-butylated phenyl groups.

In a further embodiment according to the invention, the transition metal compound according to the invention comprises at least one phosphite compound of the formula (I), wherein the ring denoted by “A” in in at least one group represented by formula (II) is an aromatic group, which optionally may have one or more further substituents apart from R¹ and R². Preferably, the aromatic ring A in at least one group represented by formula (II) is a phenyl group or a naphthyl group, more preferably a phenyl group.

It is also preferred that the ring A in at least one group represented by formula (II) is selected from the preferred aromatic groups listed above, and R¹R² and, if present further substituents, are either identical or different from each other, and preferably R¹ and R² are selected from the group of C1-C6 alkyls, more preferably from methyl, ethyl, n-propyl, iso-propyl, tert-butyl, cyclopentane, isoamyl, neopentyl, or cyclohexyl groups.

Most preferably, R¹, R² and, if present, one further substituent bonded to the phenyl ring constituting the ring A of the structure of formula (II) are selected from methyl groups and tert-butyl groups.

In a further preferred embodiment according to the invention, the ring denoted by “A” in in at least one group represented by formula (II) in the transition metal compound of the invention is a phenyl group, which optionally may have one or more further substituents apart from R¹ and R².

As already mentioned above, R¹ and R² are either identical or different from each other and are preferably independently selected from the group of C1-C6 alkyls, more preferably from methyl, ethyl, n-propyl, iso-propyl, tert-butyl, cyclopentane, isoamyl, neopentyl, pr cyclohexyl groups. Even more preferably the substituents R¹ and R² are the same and selected from tert-butyl groups or R¹ is a tert-butyl group and R² is selected from methyl or ethyl, most preferably R¹ is tert-butyl and R² is also tert-butyl or methyl.

Further preferably, the phenyl ring A in at least one group represented by formula (II) bears one, two or three further substituents apart from R¹ and R² as described before selected from the group of Si-organic groups, C1-C6 alkyl groups, more preferably from methyl, ethyl, n-propyl, iso-propyl, tert-butyl, cyclopentane, isoamyl, neopentyl, or cyclohexyl groups.

It is also preferred according to this embodiment that the phenyl ring A bears one further substituent in meta-position to R¹ and R² selected from n-alkyl groups, n-alkenyl groups, halide group, nitro groups, cyano groups, alkoxy groups, alkoxycarbonyl groups or organosilyl groups, more preferably the further substituent is selected from a methyl, iso-butyl, tert-butyl, vinyl, allyl, methoxy, ethoxy, n-propoxy, isopropoxy, methoxycarbonyl, ethoxycarbonyl, tert-butoxycarbonyl, trimethylsilyl, triethylsilyl, triisopropylsilyl groups, even more preferably R¹, R² and the further substituent in meta-position to R¹ and R² are independently selected from methyl, iso-butyl or tert-butyl groups, trimethylsilyl, triethylsilyl, triisopropylsilyl, and most preferably R¹, R² and the further substituent meta to R¹ and R² are the same type of substituent selected from methyl, iso-butyl, tert-butyl or trimethylsilyl groups.

In another embodiment according to the invention, the transition metal compound according to the invention comprises at least one phosphite compound of the formula (I), wherein the groups R¹ and R² in the group R represented by the formula (II) are each optionally substituted linear, branched or cyclic alkyl groups, preferably having up to 10 carbon atoms, more preferably up to 6 carbon atoms.

According to this embodiment, the groups R¹ and R² in the group represented by the formula (II) which may be the same or different, are preferably selected from optionally substituted linear alkyl groups selected from methyl, ethyl, n-propyl, n-butyl, n-pentyl, n-hexyl, n-heptyl or n-octyl groups, from optionally substituted branched cyclic alkyl groups selected from isobutyl, tert-butyl, isoamyl, neo-pentyl, iso-hexyl, or neo-hexyl, or from optionally substituted cyclopropyl, cyclobutyl, cyclopentyl, or cyclohexyl groups.

The linear, branched or cyclic alkyl groups constituting the groups R¹ and R² in the group represented by the formula (II) may be substituted with alkoxy groups, alkoxycarbonyl groups, halide group, nitro groups, cyano groups or Si-organic groups.

In a further embodiment according to the invention, the phosphites of formula (I) comprised by the transition metal compound according to the invention are selected from the compounds of formula (VI):

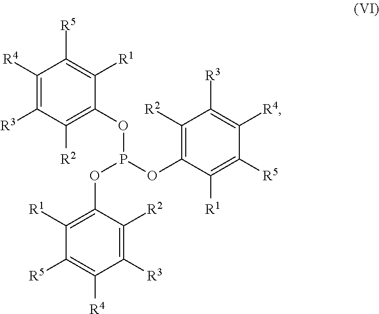

or selected from compounds of the formula (VII),

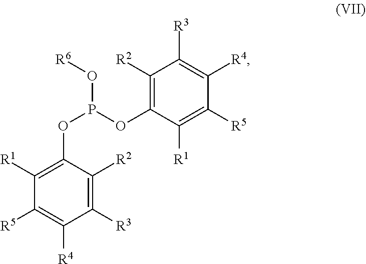

wherein in formulae (VI) and (VII) R¹, R² and R⁶ are each as defined above, and R³, R⁴, and R⁵ are each independently selected from hydrogen, halogen, cyano, nitro, Si-organic and organic groups, preferably optionally substituted aliphatic groups, and wherein in formulae (VI) at least two of the substituent groups:

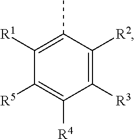

wherein the dotted line represents a single bond to the oxygen atom of the phosphite compound of the formula (I), are different from each other, and wherein in formula (VII) the two substituent groups

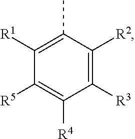

wherein the dotted line represents a single bond to the oxygen atom of the phosphite compound of the formula (I), are preferably the same.

While R¹ and R² are as defined above, it is preferred that R³-R⁵ are independently selected from hydrogen, C1-C12 alkyl groups and organosilyl groups more preferred from hydrogen, methyl, ethyl, iso-propyl, tert-butyl, cyclopentenyl, cyclohexyl and trimethylsilyl groups.

It is further preferred that one or more of the groups R of the formula (II) comprised by the formulas (VI) and (VII) are mono-, di- or tri-tert-butylated phenyl rings, and that the total number of substituents other than hydrogen on the phenyl ring is four or less, even more preferably three or two. An aliphatic group constituting R³, R⁴, and R⁵ may be substituted with alkoxy groups, alkoxycarbonyl groups, halide group, nitro groups, cyano groups or Si-organic groups.

In a further embodiment according to the invention, the phosphites of the formula (I) comprised by the transition metal compound are monodentate ligands. Accordingly, the phosphites of the formula (I) have only a single site coordinating with the metal central atom of the transition metal compound. Likewise, the transition metal atom or atoms of the transition metal compound comprising a phosphite of the formula (I) is not part of a metallacycle.

In still a further embodiment according to the invention, the groups R of the phosphites of the formula (I) comprised by the transition metal compound do not contain any metal atoms. According to this embodiment, it is explicitly excluded that any of the groups R of the phosphites of the formula (I) comprises a metal atom, be it as constituent of a metallacycle, a cation being the counter-ion to an organic anionic group, or as a part of a organometallic residue, such as for example a ferrocenyl group.

In another embodiment according to the invention, the groups R of the phosphites of the formula (I) comprised by the transition metal compound do not contain any nitrogen atoms. According to this embodiment, the groups R of the phosphites of the formula (I) do not comprise any nitrogen atoms, and thus the presence of any nitrogen containing residues and substituents such as amino groups, nitro groups, imino groups and amide groups are excluded from the groups R.

In still another embodiment according to the invention, the groups R of the phosphites of the formula (I) comprised by the transition metal compound do not comprise any groups containing N or P atoms, preferably do not comprise any groups containing N, P, S or Se atoms, and most preferably do not comprise any groups containing N, P, S, Se or O atoms.

The absence of the heteroatoms cited above is preferred according to this embodiment, as they may exhibit coordination to the central metal atom of the transition metal compound, and thus the presence of the heteroatoms or functional groups comprising the same may interfere with the coordination of the phosphorus atom of the phosphite of the formula (I) to the central metal atom in an undesired way.

In a preferred embodiment according to the invention, the groups R of the phosphites of the formula (I) can only contain C, H, O atoms and halogen atoms, wherein the O atoms can only be present in ether bonds or in ester groups, and preferably the groups R can only contain C, H and halogen atoms, and most preferably the groups R in the phosphites of the formula (I) consist of C and H atoms.

In a specific embodiment according to the invention, the transition metal compound according to the invention comprises at least one phosphite of formula (I) selected from

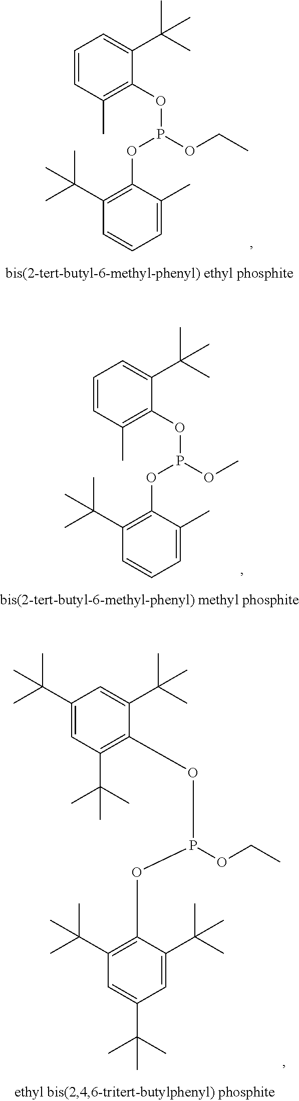

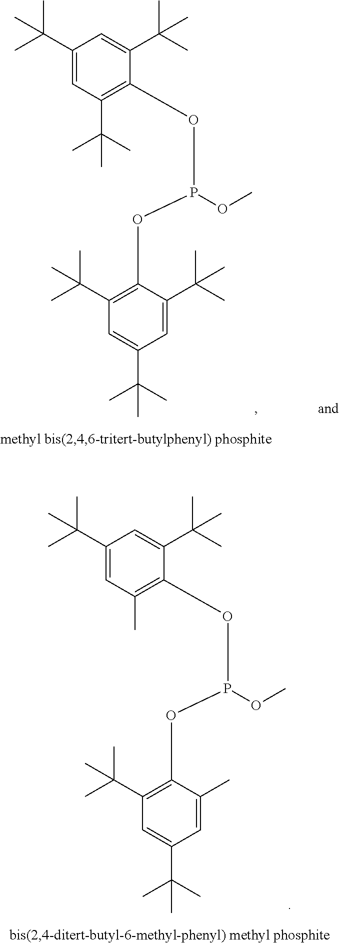

The compounds according to this embodiment have been found to provide particularly excellent results regarding pot-life, i.e. storage stability, and at the same time have high curing rates at high temperature when used as curing catalysts for curable polyorganosiloxane and/or silane compositions. The provision of high curing rates is not affected upon long-term storage of the transition metal compounds according to this embodiment.

In a further preferred embodiment according to the embodiment, the phosphite compound of the formula (I) of the transition metal compound is selected from

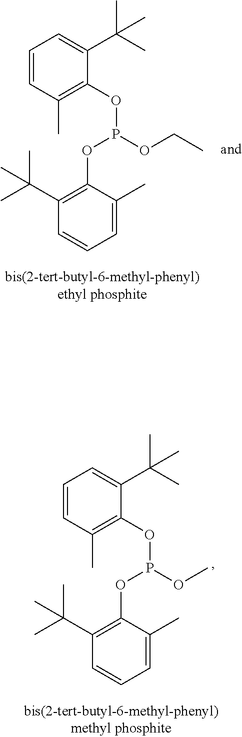

wherein

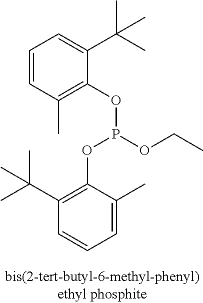 [SMILES: CCOP(Oc1c(C)cccc1C(C)(C)C)Oc1c(C)cccc1C(C)(C)C]

is preferred.

Therein, it is even further preferred that the phosphite of the formula (I) is

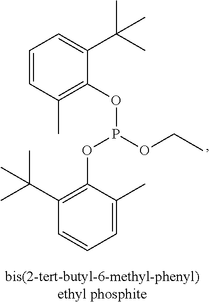 [SMILES: CCOP(Oc1c(C)cccc1C(C)(C)C)Oc1c(C)cccc1C(C)(C)C]

and the transition metal is platinum.

In a further embodiment according to the invention, the transition metal of the transition metal compound according to the invention is selected from the group consisting of nickel, ruthenium, rhodium, palladium, osmium, iridium, and platinum.

The selection of the transition metal from the list above, i.e. of a suitable precursor compound containing such transition metal for the preparation of the transition metal compound according to the invention, is made in each individual case based on the desired temperature and the required time for performing the envisaged hydrosilylation reaction, in particular in the curing of silicone compositions, in the presence of all other ingredients of the reactive composition.

The choice of the central atom(s) of a catalytic complex is generally based on the properties of the transition metal compound, and the ease of preparation of such complex from a transition metal-containing precursor compound and the corresponding phosphites beforehand or in situ. According to this embodiment, the most preferred transition metal compound is platinum.

In a further preferred embodiment according to the invention, the transition metal of the transition metal compound according to the invention is platinum.

As already mentioned, platinum is the most preferred transition metal for the formation of the transition metal complex. Pt-based transition metal compounds according to the invention, i.e. compounds comprising at least one phosphite compound of the formula (I) containing at least one group R represented by the formula (II), may be formed starting from platinum compounds such as hexachloroplatinic acid, Speier's catalyst, Ashby's catalyst or Karstedt's catalyst.

In a further embodiment according to the invention, the transition metal compound is a transition metal complex compound wherein the transition metal has the oxidation state zero (0), preferably the transition metal complex compound is a Pt (0)-compound.

Oxidation state (0) complexes, in particular Pt (0) complexes, can catalyze hydrosilylation reactions at very high reaction rates. The compounds according to this embodiment, which also comprise at least one phosphite compound as described in the previous embodiments, display the desired high reaction rates at elevated temperatures, which enables the provision of curable compositions having an unusual long pot life and high curing rates at elevated temperatures.

In another embodiment according to the invention, the transition metal compound according to the invention comprises one or more alkenyl ligands.

The one or more alkenyl ligands can be any compounds having at least one C—C double bond, wherein the C—C double bonds may be internal C—C bonds or C—C bonds in a terminal position of the carbon scaffold of the ligand compound.

Preferably at least one of the one or more C—C double bonds of the alkenyl ligand is in a terminal position.

Typically, the alkenyl ligands according to the embodiments are selected from monoalkenes, dienes, trienes, polyenes or keto-alkenes, preferably from monoalkenes, dienes and trienes. Examples of monoalkenes, which are compounds containing one C—C double bond serving as alkenyl ligands according to this embodiment are ethene, isobutene, cyclohexene, cyclooctene, tetrafluoroethylene, maleic anhydride, and esters of fumaric acid, e.g. fumaric acid dimethyl ester, fumaric acid diethyl ester, or fumaric acid diisopropyl ester.

Examples of dienes, which are compounds containing two C—C double bonds serving as alkenyl ligands according to this embodiment are butadiene, isoprene, cyclohexadiene, cyclooctadiene, norbornadiene, and C5-C10 alkadienes terminated by C—C double bonds, for example 1,7-octadiene.

Examples of trienes and tetraenes, which are compounds containing three or four C—C double bonds, respectively, serving as alkenyl ligands according to this embodiment are cycloheptatriene and cyclooctatetraene.

The alkenyl ligands may also be selected from polyenes containing even more than four C—C double bonds, or ketoalkenes.

Further preferred alkenyl ligangs selected from the group cited above are alkenyl siloxane ligands, which according to the present invention are characterized by the presence of at least one organosiloxane group and at least one alkenyl group.

In a further preferred embodiment according to the invention, the transition metal compound according to the invention comprises one or more alkenyl siloxane ligands.

According to the invention, any ligand containing one or more C—C double bonds and one or more organosiloxane units is considered an alkenyl siloxane ligand. Preferably, the alkenyl siloxane ligands contain two or more C—C double bonds, wherein it is further preferred that the siloxane ligands contain two terminal C—C double bonds, in particular two terminal C—C double bonds provided by terminal vinyl siloxane moieties. In addition, it is preferred that the alkenyl siloxane ligands contain two or more siloxane groups, preferably two to 100 adjacent siloxane groups, wherein it is particularly preferred that the adjacent siloxane groups form an unbranched linear structure or an unbranched cyclic structure.

Examples of preferred alkenyl siloxane ligands are 1,3-divinyltetramethyldisiloxane (Vinyl-M2, used for example as ligand in the Karstedt catalyst), and tetravinyltetramethyl-tetracyclosiloxane (Vinyl-D4).

In a still further preferred embodiment according to the invention, the transition metal compound according to the invention is represented by the formula:

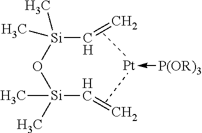

wherein P(OR)₃ is a phosphite of the formula (I) and is as defined above and described in the embodiments described above.

The transition metal compound according to this embodiment can be obtained by adding the phosphites of the formula (I) as described above to a solution of the Pt-based Karstedt catalyst or to a curable composition or a part of a curable composition comprising the Pt-based Karstedt catalyst. It is noted that in general the features of the embodiments of the transition metal compound comprising the phosphite of the formula (I) described above can be combined independently unless this is not possible for merely logical reasons.

Another aspect of the invention relates to the use of the transition metal compound of formula (I) as defined in any of the previous embodiments as a curing catalyst for curable polyorganosiloxane compositions and/or silane compositions.

The transition metal compounds according to the invention as described above can be used beneficially as a curing catalyst for curable polyorganosiloxanes and/or silane compositions because they catalyze the hydrosilylation reaction required for curing such compositions at elevated temperatures with a high reaction rate while they also allow the provision of compositions with an extended pot-life when compared to curing catalysts of the prior art. Therein, the transitions metal compounds according to the invention used for curing curable polyorganosiloxane compositions and/or silane compositions can be prepared prior to the use for curing above-mentioned compositions and may optionally be isolated if desired, or the transition metal compounds may be formed in the composition to be cured by the addition of suitable precursor compounds, e.g. a transition metal salt or complex and a phosphite of the formula (I) as described above.

While the use of the transition metal compounds comprising a phosphite of the formula (I) according to the invention as described above in detail as a curing catalyst for all types of curable polyorganosiloxane compositions and/or silane compositions falls within the scope of the invention, the invention primarily refers to hydrosilylation-curing polyorganosiloxane compositions and/or silane compositions, i.e. to compositions in which the curing of the composition is effected by a hydrosilylation reaction of at least one compound containing one or more Si—H groups to at least one compound containing one or more unsaturated C—C bonds via an addition reaction of said groups.

In particular, the transition metal compound comprising a phosphite of the formula (I) as defined above is used for the curing of curable polyorganosiloxane compositions and/or silane compositions as described in the following next aspect of the invention:

Another aspect of the invention relates to curable polyorganosiloxane compositions and/or silane compositions, comprising one or more transition metal compounds comprising a phosphite of the formula (I) as defined above.

While this aspect of the invention relates to all types of curable polyorganosiloxane compositions and/or silane compositions compounds comprising a phosphite of the formula (I), it primarily refers to hydrosilylation-curing polyorganosiloxane compositions and/or silane compositions, i.e. to compositions in which the curing of the composition is effected by a hydrosilylation reaction of compounds containing one or more Si—H groups and compounds containing one or more unsaturated C—C bonds via an addition reaction of said groups.

Such curable polyorganosiloxane composition and/or silane composition according to the invention comprises one or more compounds containing one or more unsaturated C—C bonds, and one or more compounds containing one or more Si—H moieties.

The transition metal compounds comprising a phosphite of the formula (I) as described above can be used beneficially as a curing catalyst for curable polyorganosiloxanes and/or silane compositions because they catalyze the hydrosilylation reaction required for curing such compositions at elevated temperatures with a high reaction rate, while they also allow the provision of compositions with an extended pot-life when compared to curing catalysts of the prior art.

The transitions metal compounds comprising a phosphite of the formula (I) comprised by curable polyorganosiloxane compositions and/or silane compositions according to the invention may be added as isolated compounds, or they may be preformed in situ by mixing a transition metal-containing precursor compound and one or more of the phosphites of the formula (I), preferably in a solvent, and added without isolation of the transition metal compounds of the invention or without any further work-up, e.g. as solution in a solvent, or they may be formed in situ in the curable composition by the addition of suitable transition metal-containing precursor compounds, e.g. a transition metal salt or complex like Karstedt's catalyst or Ashby's catalyst, and one or more phosphites of the formula (I) as described above to the curable polyorganosiloxane and/or silane composition.

A curable polyorganosiloxane composition and/or silane composition according to the invention thus typically comprises one or more compounds containing two or more unsaturated C—C bonds, one or more compounds containing two or more Si—H moieties, and one or more transition metal compounds comprising a phosphite of the formula (I).

It is noted that usually there is an excess amount of the phosphite of the formula (I) present in the curable composition according to the invention, because the phosphites of the formula (I) are applied in excess over the transition metal-containing precursor compound when forming the transition metal compound comprising the phosphite of the formula (I) in order to achieve full conversion of the transition metal-containing precursor compound.

Accordingly, the curable composition preferably contains one or more phosphites of the formula (I) in addition to the phosphites of the formula (I) comprised by the one or more transition metal compounds comprising phosphites of the formula (I) comprised by the curable composition.

According to the invention, it is preferred that the curable polyorganosiloxane composition and/or silane composition comprises
(A) one or more polyorganosiloxanes and/or silanes having in average at least two alkenyl groups, and
(B) one or more polyorganosiloxanes and/or silanes having in average at least two SiH groups,
(C) one or more transition metal compounds, wherein the transition metal is selected from group consisting of nickel, ruthenium, rhodium, palladium, osmium, iridium, and platinum,
(D) optionally one or more phosphites of the formula (I) as defined in any of the previous embodiments, and
(E) optionally one or more auxiliary agents.

The curable polyorganosiloxane compositions and/or silane compositions comprising a phosphite of the formula (I) may be dissolved, dispersed, suspended or emulgated in liquids, if required. All viscosities indicated herein are determined according to DIN 53019 and, unless otherwise noted, at 25° C. and a shear rate of D=10 s⁻¹

The components (A) to (E) cited above are defined as follows:

### Component (A)

The inventive composition comprises one or more polyorganosiloxanes and/or silanes having in average at least two alkenyl groups (A), e.g. those disclosed in U.S. Pat. Nos. 3,096,303, 5,500,148 A (examples). Suitable compounds (A) can be described by the general formula (III′),

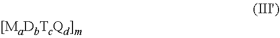

wherein the formula (III′) represents the ratios of the siloxy units M, D, T and Q, which can be distributed blockwise or randomly in the polymer chain. Within a polysiloxane chain each siloxane unit can be identical or different and preferably
   a=1-10, preferably 2-8, more preferably 2-7, even more preferably 2-6,
   b=0-12000, preferably 1-10000, more preferably 2-8000, even more preferably 5-6000, further preferably 20-4000,
   c=0-50, preferably 0-25, more preferably 0-8, and also preferably 1-48, more preferably 2-45, even more preferably 3-40, further preferably 5-30,
   d=0-1
   m=1-5000, preferably 1-4800, more preferably 1-4200, even more preferably 1-3500, further preferably 1-2500.

These indices should represent the average polymerisation degree Pₙ based on the average number molecular mass Mₙ.

The polymer (A) is selected from the group of alkenyl-containing polyorganosiloxanes, which can undergo hydrosilylation reactions with hydrogen siloxanes to form silicon carbon bonds.

The polymer (A) or mixtures thereof comprise groups selected from
M=R′₃SiO_{1/2}, or M*
D=R′₂SiO_{2/2}, or D*
T=R′SiO_{3/2}, or T*
Q=SiO_{4/2},
divalent R²′-groups,
wherein M*=R¹′ₚR′₃₋ₚSiO_{1/2}, D*=R¹′_{q}R′_{2-q}SiO_{2/2}, T*=R¹′SiO_{3/2},
wherein
p=1-3,
q=1-2.

R′ is preferably selected from n-, iso, or tertiary C₁-C₃₀-alkyl, alkoxyalkyl, C₅-C₃₀-cyclic alkyl, or C₆-C₃₀-aryl, alkylaryl, which groups can be substituted by one or more O—, N—, S- or F-atom, e.g. ethers or amides or poly(C₂-C₄)-alkylene ethers with up to 1000 alkylene oxy units.

Examples of said monovalent residues R′ in component (A) include hydrocarbon groups and halohydrocarbon groups.

Examples of suitable monovalent hydrocarbon radicals include alkyl radicals, preferably such as CH₃—, CH₃CH₂—, (CH₃)₂CH—, C₈H₁₇— and C₁₀H₂₁—, cycloaliphatic radicals, such as cyclohexylethyl, aryl radicals, such as phenyl, tolyl, xylyl, aralkyl radicals, such as benzyl and 2-phenylethyl. Preferable monovalent halohydrocarbon radicals have the formula CₙF₂ₙ₊₁CH₂CH₂— wherein n has a value of from 1 to 10, such as, for example, CF₃CH₂CH₂—, C₄F_{g}CH₂CH₂—, C₆F₁₃CH₂CH₂—, C₂F₅—O(CF₂—CF₂—O)₁₋₁₀CF₂—, F[CF(CF₃)—CF₂—O]₁₋₅—(CF₂)₀₋₂—, C₃F₇—OCF(CF₃)— and C₃F₇—OCF(CF₃)—CF₂—OCF(CF₃)—.

Preferred groups for R′ are methyl, phenyl, 3,3,3-trifluoropropyl.

R¹′ is selected from unsaturated groups, comprising C═C-group-containing groups (alkenyl groups), e.g.: n-, iso-, tertiary- or cyclic-C₂-C₃₀-alkenyl, C₆-C₃₀-cycloalkenyl, C₈-C₃₀-alkenylaryl, cycloalkenylalkyl, vinyl, allyl, methallyl, 3-butenyl, 5-hexenyl, 7-octenyl, ethyliden-norbornyl, styryl, vinylphenylethyl, norbornenyl-ethyl, limonenyl, substituted by one or more O- or F-atoms, e.g. ethers, amides or C₂-C₄-polyethers with up to 1000 polyether units. The alkenyl radicals are preferable attached to terminal silicon atoms, the olefin function is at the end of the alkenyl group of the higher alkenyl radicals, because of the more ready availability of the alpha-, omega-dienes used to prepare the alkenylsiloxanes.

Preferred groups for R¹′ are vinyl, 5-hexenyl.

R²′ includes for example divalent aliphatic or aromatic n-, iso-, tertiary- or cyclo-C₁-C₁₄-alkylene, arylene or alkylenearyl groups which bridge siloxy units. Their content does not exceed 30 mol-% of all siloxy units. Preferred examples of suitable divalent hydrocarbon groups R² include any alkylene residue, preferably such as —CH₂—, —CH₂CH₂—, —CH₂ (CH₃) CH—, —(CH₂)₄—, —CH₂CH(CH₃) CH₂—, —(CH₂)₆—, —(CH₂)₈— and —(CH₂)₁₈—; cycloalkylene radical, such as cyclohexylene; arylene radicals, such as phenylene, xylene and combinations of hydrocarbon radicals, such as benzylene, i.e. —CH₂CH₂—C₆H₄—CH₂CH₂—, —C₆H₄CH₂—. Preferred groups are alpha, omega-ethylene, alpha, omega-hexylene or 1,4-phenylene.

Examples of suitable divalent halohydrocarbon radicals R² include any divalent hydrocarbon group wherein one or more hydrogen atoms have been replaced by halogen, such as fluorine, chlorine or bromine. Preferable divalent halohydrocarbon residues have the formula-CH₂CH₂ (CF₂)₁₋₁₀CH₂CH₂-such as for example, —CH₂CH₂CF₂CF₂CH₂CH₂— or other examples of suitable divalent hydrocarbon ether radicals and halohydrocarbon ether radicals including-CH₂CH₂OCH₂CH₂—, —C₆H₄—O—C₆H₄—, —CH₂CH₂CF₂₀CF₂CH₂CH₂—, and —CH₂CH₂OCH₂CH₂CH₂—.

Such polymers containing R′, R¹′ and/or R²′ radicals are polyorganosiloxanes, e.g. alkenyl-dimethylsiloxy or trimethylsiloxy terminated polydimethylsiloxanes, which can contain other siloxane units than alkenylmethylsiloxy groups dimethylsiloxy groups such as poly-(dimethyl-co-diphenyl) siloxanes.

Broadly stated component (A) of the compositions of this invention can be any polyorganosilicone compound containing two or more silicon atoms linked by oxygen and/or divalent groups R²′ wherein the silicon is bonded to 0 to 3 monovalent groups per silicon atom, with the proviso that the organosilicon compound contains at least two silicon-bonded unsaturated hydrocarbon residues. This component can be a solid or a liquid, free flowing or gum-like i.e. it has measurable viscosity of less than 100 kPa·s at a shear rate of D=1 s⁻¹ at 25° C.

The polyorganosilicone compound containing at least two silicon-bonded unsaturated hydrocarbon residues (A) preferably has a viscosity in the range of 10 to 100,000,000 mPa·s at 25° C. at a shear rate of D=10 s⁻¹, the preferred range is about 100 to 10,000,000 mPa·s, more preferably the viscosity is in the range of 200 to 1,000,000 mPa·s, even more preferably in the range of 200 to 500,000 mPa·s, and most preferably in the range of 200 to 200,000 mPa·s (according to DIN 53019).

The siloxane units with radicals R′ and/or R¹′ can be equal or different for each silicon atom. In a preferred version the structure is represented by the general formulas (III′a) to (IlI′b), shown below.

A preferred polyorganosiloxane component (A) for the composition of this invention is a substantially linear polyorganosiloxane (A) having the formula (III′a) or (III′e) to (III′i). The expression “substantially linear” includes polyorganosiloxanes that contain not more than 0.2 mol-% (trace amounts) of siloxy units of the type T or Q. This means the polymer (A) is preferably a linear, flowable fluid or gum (A1) with a Newton like viscosity but not solid at 25° C.

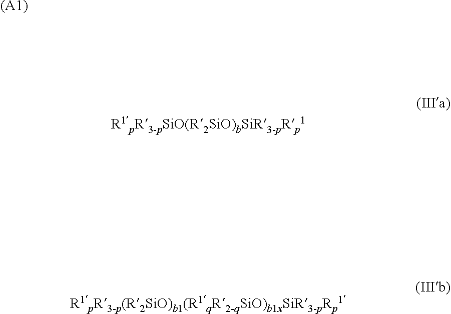

b=>0-12000, more preferred 10 to 9000, even more preferred 50 to 5000, and even further preferred 50 to 1000,
b1=>0-12000, more preferred 10 to 9000, even more preferred 50 to 5000, and even further preferred 50 to 1000,
b1x=0-1000, more preferred 1 to 500, even more preferred 10 to 200, and even further preferred 10 to 100,
b1+b1x=>0-12000, more preferred 10 to 9000, even more preferred 50 to 5000, and even further preferred 60 to 1000,
p=0 to 3
q=1 to 2,
with the proviso, that there are at least two alkenyl groups per molecule.

Preferred groups for R′ are methyl, phenyl, 3,3,3-trifluoropropyl.

Preferred groups for R¹′ are vinyl, hex-5-enyl and cyclohexenyl-2-ethyl.

The average polymerization degrees Pₙ or ‘b’ etc. is based on Mₙ as average number mol mass in the range of up to 12000, the preferred range is 400 to 5000.

The polyorganosilicone compound containing at least two silicon-bonded unsaturated hydrocarbon residues (A) preferably has a viscosity in the range of 10 to 100,000,000 mPa·s at 25° C. at a shear rate of D=10 s⁻¹, the preferred range is about 100 to 10,000,000 mPa·s, more preferably the viscosity is in the range of 200 to 1,000,000 mPa·s, even more preferably in the range of 200 to 500,000 mPa·s, and most preferably in the range of 200 to 200,000 mPa·s

Such a viscosity at 25° C. for the component (A) is suitable for the application of the manufacturing of broad variety of products such as molded or extruded shaped rubber parts with liquid silicone rubbers and high viscous rubbers, curable ‘Formed-in-Place’-sealants well as coatings of substrates.

In the group of alkenyl-comprising siloxanes (A) the addition of other so-called vinyl rich polymers (A2) is preferred in order to modify mechanical properties.

The polymers (A2) are selected either from the group consisting of polymers of the formulas (III′b) to (III'd) or (III′h) to (III′i), i.e. linear polyorganosiloxanes having additional alkenyl side groups or branched polyorganosiloxanes having a higher concentration of T- and Q-groups than the previous types:

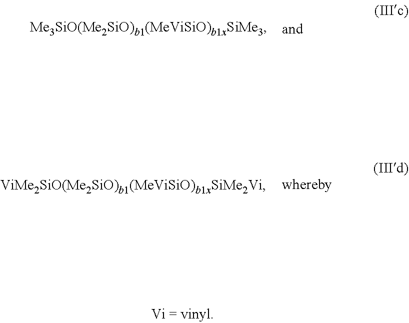

The preferred value of b1x is less than 0.5*b1 or zero. If b1x is not zero then it is preferably between 0.0003*b1 to 0.25*b1 preferably 0.0015*b1 to 0.15*b1.

Other preferred structures according of the formulas (III′e) to (III′i) achieve suitable viscosities as defined later on and describe polymers applicable without any solvent for a viscosity adjustment. The range of subindices defines a range of the possible average polymerization degrees Pₙ.

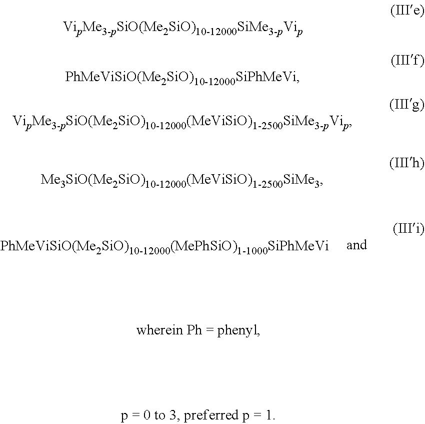

In a preferred embodiment the polymer component (A) is a mixture of polymers of the formula (III′a) and of the formula (III′b) or (III′h) whereby (III′b) has an alkenyl content of 1 to 50 mol-% in a ratio in that the alkenyl content of mixture of (A1) and (A2) is below 2 mol-%.

Another class of preferred polymers are branched polyorganosiloxanes (A2) having a high concentration of SiMe₍₃₋ₚ₎(alkenyl)ₚ groups with distinct cure rates. Such structures are especially used in release coating applications. Branched polymers are described e.g. in U.S. Pat. No. 5,616,672 and are preferably selected from those of the formula (III′) wherein the polyorganosiloxane (A2) comprising alkenyl groups has more than 0.2 mol-% of T=R′SiO_{3/2} or Q=SiO_{4/2}— units.

Preferably the branched vinyl-rich polymers have a range of D:T >10:1 preferably >33:1 and/or respectively (M^{alkenyl}:Q)=0.6-4:1.

All these polymers can be prepared by any of the conventional methods for preparing triorganosiloxane-terminated polydiorganosiloxanes. For example, a proper ratio of the appropriate hydrolyzable silanes, e.g., vinyldimethylchlorosilane and dimethyldichlorosilane, may be co-hydrolyzed and condensed or alternately an appropriate 1,3-divinyltetraorganodisiloxane, e.g., symmetrical divinyldimethyldiphenylsiloxane or divinyltetramethylsiloxane, which furnishes the endgroups of the polydiorganosiloxane, may be equilibrated with an appropriate dipolyorganosiloxane, e.g., octamethylcyclotetrasiloxane, in the presence of an acidic or basic catalyst. Regardless of the method of preparation of polydiorganosiloxane (A), there is usually coproduced a varying quantity of volatile, cyclic polydiorganosiloxanes.

The viscosities of the polydiorganosiloxanes (A) defined above for the purposes of this invention, refer preferably essentially free of cyclic polydiorganosiloxanes (less than 1 wt. %, preferably 0.5 wt. % measured for 1 h 150° C. 20 mbar) portion of the polyorganosiloxane. This essentially cyclic free portion can be prepared by stripping the polydiorganosiloxane at 150° C. for at least 1 hours to yield a polymer residue of this type. This residue will be essentially free of cyclic material with the exception of trace quantities of macrocyclic polydiorganosiloxanes (molecular weight >518 g/mol) which are non-volatile as defined above.

The average polymerization degree Pₙ of the polymer (A) measured by GPC measurement versus polystyrene standard based on the average number mol weight Mₙ is preferably in the range of >10 to 12000, the more preferred range is 40 to 6000, the range of 60 to 3000 is even more preferred, and the range of 70 to 1500 is even further preferred. The viscosities of such polymers are in the range of 10 to 50,000,000 mPa·s at 25° C. at a shear rate of D=10 s⁻¹. The value for Pₙ or the index ‘b’ in the above formula (III′a) is such that the linear polyorganosiloxane (A) has a viscosity at 25° C., of at least 10 mPa·s. Preferably the range of the viscosity is from about 40 mPa·s to 35,000,000 mPa·s and, more preferably from 100 mPa·s to 25,000,000 mPa·s, further preferably from of 500 to 1,000,000 mPa·s, even more preferably in the range of 800 to 500,000 mPa·s, and even further preferably in the range of 2,000 to 200,000 mPa·s, and most preferably in the range of 2000 to 100,000 mPa·s. Said viscosity corresponds approximately to the values of the average Pₙ, indicated by ‘b’ or ‘b1+b1x’.

The concentration of the functional unsaturated groups are in the range of 50 mol-% to 0.033 mol-% (mol-% of functionalized Si-atoms per total of Si-atoms), i.e. in case of polydimethylsiloxanes about preferably 0.002 to 12 mmol/g, more preferred 0.004-3 mmol/g. Said siloxane units can be combined in any molecular arrangement such as linear, branched, cyclic and combinations thereof, to provide polyorganosiloxanes (A1) and (A2) that are useful as component (A). In a preferred embodiment the hydrosilylation-curable composition is solvent-less (less than 1 wt.-% volatiles).

The alkenyl content of the components (A) can be determined here by way of 1H NMR-see A. L. Smith (ed.): The Analytical Chemistry of Silicones, J. Wiley & Sons 1991 Vol. 112 pp. 356 et seq. in Chemical Analysis ed. by J. D. Winefordner.

The component (A) can be also selected of the group of silanes such as of the general formulae:

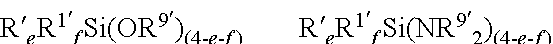

wherein R′, R¹′ is as defined above, R⁹′ is as defined below, and

$$\begin{matrix}e = 0 - 3 \\ f = 1 - 4 , and \\ e + f = 4 ;\end{matrix}$$

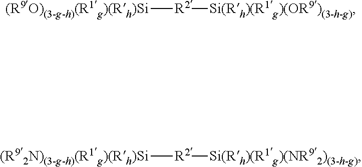

wherein R′, R¹′ and R²′ is as defined above, R⁹′ is as defined below, and

$$\begin{matrix}g = 1 - 3 , \\ h = 0 - 2 , and \\ g + h = 3 .\end{matrix}$$

According to the invention, particularly preferred polyorganosiloxanes having in average at least two alkenyl groups are
dimethylvinylsilyl-terminated polydimethylsiloxanes of the general average composition of MVi₂Dₘ, wherein m is in the range of from 50 to 1500, preferably 60 to 1400, more preferably 70 to 1400, even more preferably 70 to 1000.
dimethylvinylsiloxy-terminated poly(dimethylsiloxane-co-methylvinylsiloxane) of the general average composition MVi₂DₙDViₒ, wherein n is in the range of from 100 to 1000, preferably 200 to 900, more preferably 300 to 800, and even more preferably 400 to 700, and o is independently in the range of from 10 to 120, preferably in the range of 15 to 90, more preferably in the range of 20 to 70, even more preferably in the range of 25 to 50, for example dimethylvinylsiloxy-terminated poly(dimethylsiloxane-co-methylvinylsiloxane) of the average composition MVi₂D₅₆₀DVi₃₆.

### Component (B)—(Crosslinker)

The curable compositions of the invention comprise a crosslinker and/or chain extender component (B) for the polymers defined under (A). The component (B) is from the group consisting of silanes and polyorganosiloxanes having at least 2 SiH groups in average, which can react with alkenyl groups of the polymers (A) and crosslink both polymers to an elastomeric network. In order to get a more elastomeric behaviour rather than a gel it is preferred that at least 30 mol.-% of the component (A) or (B) should have a functionality of reactive groups of 3 or more (number of Si-alkenyl groups per total of Si atoms for (A) and number of SiH-groups per total of Si atoms for (B)).

The component (B) is preferably selected from the group of SiH-containing polyorganosiloxanes and SiH-containing organosilanes respectively hydrogen silyl modified hydrocarbons. Suitably component (B) is composed of siloxane units selected from the groups M=R′₃SiO_{1/2}, M^{H}=R′YSiO_{1/2}, D=R′₂SiO_{2/2}, D^{H}=R′YSiO_{2/2}, T=R′SiO_{3/2}, T^{H}=YSiO_{3/2}, SiO_{4/2}, wherein R′ is as defined above and Y═R¹′ and/or H, with the proviso that there are in average at least two SiH-groups per molecule.

For example, they include:

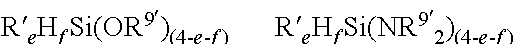

wherein R′ is as defined above, R⁹′ is as defined below, and

$$\begin{matrix}e = 0 - 3 \\ f = 1 - 4 , and \\ e + f = 4.\end{matrix}$$

Further

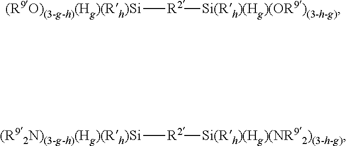

wherein g, h, R′, R²′, R⁹′ is as defined above or below.

This means the polymer (B) can be formally described by the ratios of the general formula (IV′),

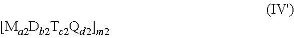

wherein the siloxy units M, D, T and Q are as defined above including the possible SiH-containing M, D, T groups. Also possible is that part of the siloxy groups are alkenyl siloxy groups, as long as there are at least in average two SiH-groups per molecule. The siloxy units can be distributed blockwise or randomly in the polymer chain. Within a polysiloxane chain each siloxane unit can be identical or different, and preferably
   a2=1-100, preferably 1 to 40, more preferably 1-10, even more preferably 2-5
   b2=0-1000, preferably 2-500, more preferably 5 to 250
   c2=0-50, preferably 0-45, more preferably 0 to 40, even more preferably 0 to 30, even further preferably 0-20, still further preferably 1 to 20
   d2=0-1
   m2=1-2000, preferably 1-1500, more preferably 1 to 120, even more preferably 1 to 100, even further preferably 1-80.

The aforementioned indices should represent the average polymerisation degree Pₙ based on the average number molecular mass Mₙ.

The range for M-, D-, T- and Q-units present in the molecule can cover nearly all values representing fluids, flowable polymer, liquid and solid resins. It is preferred to use liquid silanes or liquid linear, cyclic or branched siloxanes comprising optionally remaining C₁-C₃-alkoxy or Si-hydroxy groups remaining from the synthesis. These compounds can have a low molecular weight or are condensation products, which can be partially hydrolysed, as well as siloxanes polymerized via an equilibration or condensation under the assistance of acidic catalysts.

The siloxane units with radicals R′ or Y can be equal or different for each silicon atom.

The preferred structures of reactive polyorganosiloxanes for component (B) in the compositions of this invention are silanes or condensed silanes/siloxanes of formula (IV′a) to (IV′d).

The preferred structure composed with these units are selected from

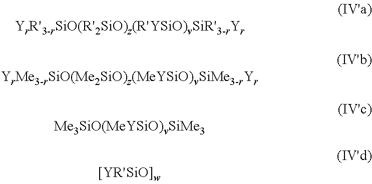

z=0 to 1000, preferably 1-250, more preferably 5 to 150, even more preferably 10 to 50,
v=0 to 100, preferably 2 to 80, more preferably 4 to 60, even more preferably 6 to 40,
z+V=1 to 1000, preferably 2 to 300, more preferably 5 to 250, even more preferably
10 to 80,
w=3 to 9
r=0 or 1,
and structures of the formula

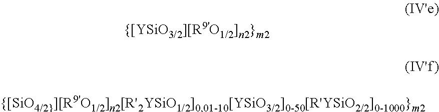

wherein
R⁹′O_{1/2} is an alkoxy residue at the silicon atom
R′ is defined above,
n2=0.001 to 3
a2=0.01-10
b2=0-1000
c2=0-50
m2=1 to 2000
Y=hydrogen or R¹′

R⁹′ is hydrogen, n-, iso-, tertiary- or cyclo-C₁-C₂₅-alkyl, such as methyl, ethyl, propyl, alkanoyl, such acyl, aryl, —N═CHR, such as butanonoxime, alkenyl, such as propenyl, which groups R⁹′ may be substituted by one or more halogen atoms, pseudohalogen groups, like cyano.

The preferred groups for Y are hydrogen.

One preferred embodiment of the compounds of class (IV′e) and (IV′f) is provided by way of example by monomeric to polymeric compounds which can be described via the formula [(Me₂HSiO_{0.5}) KSiO_{4/2}]ₘ₂ wherein index k can have integer or decimal values from 0.01 to (2*m₂+2). Such liquid or resinous molecules can contain significant concentrations of SiOH— and/or (C₁-C₆)-alkoxy-Si groups up to 10 mol-% related to the silicon atoms.

The indices z and v for the other types of preferred compounds with the formulas (IV′a) to (IV′c) are in the range of 0-1000 defined as average Pₙ based on the number average mol mass Mₙ measured by GPC versus a polystyrene standard.

Other examples of preferred suitable compounds for component (B) in the compositions of this invention include HMe₂SiO(Me₂SiO)_{z}SiMe₂H, HMe₂SiO(HMeSiO)_{w}(Me₂SiO)_{z}SiMe₂H, Me₃SiO-(MeHSiO)ᵥ—SiMe₃, Me₃SiO(HMeSiO)_{w}(Me₂SiO)_{z}SiMe₃, (MeHSiO)₃₋₆, Si(OSiMe₂H)₄, Siₓ(OSiMe₂H)_{1.7x}, MeSi(OSiMe₂H)₃. HMezSiO(Me₂SiO)_{z1} (MePhSiO)_{z2}(MeHSiO)ᵥSiMe₂H, Me₃SiO(Me₂SiO)_{z1}(MePhSiO)_{z2}(MeHSiO)ᵥSiMe₃, HMe₂SiO-(Me₂SiO)_{z1}(Ph₂SiO)_{z2}(MeHSiO)ᵥSiMe₂H-Me₃SiO(Me₂SiO)_{z1}(Ph₂SiO)_{z2}(MeHSiO)ᵥSiMe₃ wherein z1+z2=z.

The component (B) can be used as a single component of one polyorganosiloxane polymer or mixtures thereof. In another embodiment it is preferred to use mixtures of formula (IV′b) and (IV′c). If the increase of the cure rate is required, it is preferred to use some organopolysiloxanes (B) having HMe₂SiO_{0.5}— units to adjust the cure rate to shorter times.

The molecular weight of component (B) is smaller; the functionality in (B) per molecule is higher compared to component (A).

If it is necessary to still further increase the cure rate, this can be achieved by way of example via an increase of the molar ratio of SiH to Si-alkenyl, or an increased amount of catalyst (C), or an increase in the proportion of polyorganosiloxanes (B) which contain HMe₂SiO_{0.5} units. Thus, preferred components (B) include HMe₂SiO_{0.5} (MH groups), in order to provide faster curing rates.

In a further preferred embodiment, of the component (B) this component is selected from the group according to formula (IV′a) which consist of a component (B1) such as YR′₂SiO(R′₂SiO)_{z}(R′YSiO)ᵥSiR′₂Y or formula (IV′c) having a functionality of Y of 3 or more, and a component (B2) having a functionality of Y of 2 in average such as YR′₂SiO(R′₂SiO)₂SiR′₂Y, wherein Y, R′ and z are as defined above.

If (B1) and (B2) are used together, the preferred ratio of functionality SiH(B1) to (B2) is from more than 0 to 70 mol-%, and more preferably from 30 to 100 mol-% of (B2), based on (B1) and (B2).

The molecular weight for the component (B) is not critical; however it is preferred such that the polyorganosiloxane component (B) has a viscosity at 25° C. at a shear rate of D=10 s⁻¹ up from 3 to 10,000 mPa·s, preferably 5 to 3,000 mPa·s, more preferably 8 to 2500 mPa·s, even more preferably 10 to 1500 mPa·s in the case of R′=methyl. The aforementioned viscosities are also preferred for the polyorganosiloxane component (B) in general. The viscosity depends upon the kind of the R′ and Y substituents, and the ratio of the units M, D, T and Q as well as the mol weight. For polyorganosiloxanes containing only methyl groups as R′ group the range of the molecular weights expressed as Mₙ is between 136 and 100,000 g/mol, preferably between 250 and 50,000, more preferably between 400 and 25,000, and even more preferably between 1000 and 10000.

The siloxane units with radicals R′ or Y can be equal or different for each silicon atom. Each molecule can bear one or more groups independently.

The crosslinker (B) should have at least 2 or more reactive groups Y per molecule whereas the chain extender (B2) has a functionality Y of 2 to 3 in average per molecule.

The concentration of the reactive group Y is in the range of 0.2 to 100 mol-% Y groups related to Si atoms, i.e. for polydimethyl-methylhydrogensiloxane preferably about 0.1-17 mmol SiY/g, the preferred range is 0.15 to 16 mmol/g.

In one preferred embodiment, a mixture of compounds having formula (IV′c) or (IV′d) are used together with (IV′a) and/or (IV′b), where z=0, R′=methyl and the SiH concentration is preferably >7-17 mmol SiH/g and in the second compound of (B) the index z>0 wherein the SiH concentration has values of preferably 0.2 to 7 mmol SiH/g.

It is preferred to use compounds of formula (IV′a) and/or (IV′b) wherein R′=aryl, in particular phenyl, if adherence onto other substrates such as thermoplastic substrates has to be achieved.

The SiH-content in the present invention is determined by way of 1H-NMR, see A. L. Smith (ed.): The Analytical Chemistry of Silicones, J. Wiley & Sons 1991 Vol. 112 pp. 356 et seq. in Chemical Analysis ed. by J. D. Winefordner.

The ratio of the crosslinker (B) to polymer (A) necessary for getting an elastomeric network, i.e. a non-sticky surface can be calculated by the ratio of reactive groups in (B) and (A). It is preferred to have an excess of reactive groups (B):(A) of 0.7 to 20:1, preferably 1.2 to 6:1, more preferably 1.5 to 4:1 in order to ensure a certain level of multifunctional structures in the cured elastomeric network.

According to the invention, particularly preferred polyorganosiloxanes having in average at least two SiH groups are
hydride terminated poly(dimethylsiloxane)s of the general average composition MH₂Dₐ, wherein a is in the range of from 5 to 100, preferably from 8 to 80, more preferably in the range from 10 to 50, even more preferably in the range from 12 to 40, even more preferably in the range from 13 to 25, for example the hydride terminated poly(dimethylsiloxane) of the average composition MH₂D₁₇;
trimethylsilyl-terminated poly(dimethylsiloxane-co-methylhydrogensiloxane)s of the general average composition M₂D_{b}DH_{c}, wherein b is in the range of from 10 to 50, preferably 12 to 40, more preferably 14 to 40, even more preferably 15 to 30, and c is independently in the range of from 2 to 50, preferably 4 to 40, more preferably 6 to 40, even more preferably 8 to 30, for example trimethylsilyl-terminated poly(dimethylsiloxane-co-methylhydrogensiloxane)s of the average composition M₂D₂₀DH₂₀ or with an average composition of M₂D₂₀DH₁₀;
a resin type with a general average composition of MHdxQx, wherein d is in the range of 1.1 to 2.5, preferably in the range of 1.2 to 2.2, more preferably in the range of 1.3 to 2.1, and even more preferably in the range of 1.5 to 2.0, for example an average composition of MH_{1.7x}Qₓ;
trimethylsilyl-terminated polymethylhydrogensiloxanes with a general average composition of M₂DHₑ, wherein e is in the range of from 5 to 100, preferably 10 to 80, more preferably 15 to 60, even more preferably 20 to 40, for example the trimethylsilyl-terminated polymethylhydrogensiloxanes with an average composition of M₂DH₃₀; or
trimethylsilyl-terminated poly(dimethylsiloxane-co-diphenylsiloxane-co-methylhydrogensiloxane)s with a general average composition M₂D(Ph₂)_{f}DH_{g}Dₙ, wherein f is in the range of from 1 to 50, preferably 2 to 40, more preferably 3 to 25, even more preferably from 5 to 15, g is independently in the range from 2 to 50, preferably 6 to 40, more preferably 12 to 30, and h is in the range of from 1 to 50, preferably 2 to 40, more preferably 3 to 25, even more preferably from 5 to 15, for example a trimethylsilyl-terminated poly(dimethylsiloxane-co-diphenylsiloxane-co-methylhydrogensiloxane) with an average composition of M₂D(Ph₂)₂DH₂₄D₂.

### Component (C)—(Transition Metal Compound)

The curable composition according to the invention comprises at least one transition metal compound comprising a phosphite of the formula (I) as described above serving as hydrosilylation catalysts, wherein the transition metal is selected from the group of Ni, Ir, Rh, Ru, Os, Pd and Pt compounds as taught in U.S. Pat. Nos. 3,159,601; 3,159,662; 3,419,593; 3,715,334; 3,775,452 and 3,814,730.

The component (C) for the hydrosilylation reaction of the composition according to the invention is a catalyst compound, which facilitates the reaction of the silicon-bonded hydrogen atoms of component (B) with the silicon-bonded olefinic hydrocarbon substituents of component (A). The transition metal compound can be any catalytic active component containing a transition metal and comprising a phosphite of the formula (I). The catalyst (C) includes complexes with sigma- and pi-bonded carbon ligands as well as ligands with S—, N, or P atoms, metal colloids or salts of the afore mentioned metals. The catalyst can be present on a carrier such as silica gel or powdered charcoal, bearing the metal, or a compound or complex of that metal. Preferably, the metal of component (C) is any platinum complex compound.

A typical platinum containing catalyst component in the polyorganosiloxane compositions of this invention is any form of platinum (0), (II) or (IV) compounds which comprise the inventive phosphites of the formula (I). Preferred complexes are Pt (0)-alkenyl complexes, such alkenyl, cycloalkenyl, alkenylsiloxane such vinylsiloxane, because of its easy dispersibility in polyorganosiloxane systems.

A particularly useful form of the platinum complexes are the Pt (0)-complexes with aliphatically unsaturated organosilicon compound such as 1,3-divinyltetramethyldisiloxane (derived from Vinyl-M2 or Karstedt catalyst), as disclosed by U.S. Pat. No. 3,419,593 incorporated herein by reference are especially preferred, cyclohexen-Pt, cyclooctadien-Pt and tetravinyltetramethyl-tetracyclosiloxane (Vinyl-D4).

Pt⁰-olefin complexes are prepared by way of example in the presence of 1,3-divinyltetramethyldisiloxane (M^{Vi}₂) via reduction of hexachloroplatinic acid or of other platinum chlorides by the way of example by alcohols in the presence of basic compounds such as alkali carbonates or hydroxides. The transition metal compounds comprising a phosphite of the formula (I) are formed by reacting a phosphite of the formula (I) with a corresponding precursor compound, e.g. a Pt⁰-olefin complex, either in the curable composition or separately.

The amount of platinum-containing catalyst component that is used in the compositions of this invention is not narrowly limited as long as there is a sufficient amount to accelerate the hydrosilylation between (A) and (B) at the desired temperature in the required time (B) in the presence of all other ingredients of the inventive composition. The exact necessary amount of said catalyst component will depend upon the particular catalyst, the amount of other inhibiting compounds and the SiH to olefin ratio and is not easily predictable. This applies to all transition metal-containing catalysts in the same manner. However, for platinum catalysts said amount can be as low as possible due to cost reasons. Preferably one should add more than one part by weight of platinum for every one million parts by weight of the organosilicone components (A) and (B) to ensure curing in the presence of other undefined inhibiting traces. For the compositions of this invention, the amount of platinum containing catalyst component to be applied is preferably sufficient to provide from 1 to 200 ppm preferably 2 to 100 ppm, especially preferred 4 to 60 ppm by weight platinum per weight of polyorganosiloxane components (A) plus (B).

Preferably said amount is at least 4 ppm by weight per sum of (A) and (B).

Other Pt catalysts which may be used as precursor compounds are mentioned by way of example in U.S. Pat. No. 3,715,334 or U.S. Pat. No. 3,419,593, EP 1 672 031 A1 and Lewis, Colborn, Grade, Bryant, Sumpter, and Scott in Organometallics, 1995, 14, 2202-2213, all incorporated by reference here.

As explained already above, the specific phosphites of the formula (I) used in accordance with the invention interact with conventional transition metal compounds through ligand exchange reactions, thereby forming the transition metal compounds comprising a phosphite of the formula (I) and influencing the hydrosilylation activity of the catalyst to provide surprisingly an excellent balance between storage stability on the one hand and reactivity at elevated temperatures upon curing.

According to the above description of the formation of the transition metal compounds comprising a phosphite of the formula (I), the presence of a phosphite of the formula (I) and a transition metal containing precursor compound, for example a conventional transition metal-based hydrosilylation catalyst, in a curable composition is tantamount to the presence of a transition metal compound comprising a phosphite of the formula (I) (C).

According to the invention, particularly preferred transition metal compounds (C) are {η⁴-(H₂C═CHSiMe₂)₂O}{bis(2-tert-butyl-6-methyl-phenyl) ethyl phosphite}platinum, {η⁴-(H₂C═CHSiMe₂)₂O}{bis(2-tert-butyl-6-methyl-phenyl) methyl phosphite}platinum, {η⁴—(H₂C═CHSiMe₂)₂O}{bis(2,4-ditert-butyl-6-methyl-phenyl) ethyl phosphite}platinum, and {η⁴-(H₂C═CHSiMe₂)₂O}{ethyl bis(2,4,6-tritert-butylphenyl)phosphite}platinum.

### Component (D):

Optionally, one or more further phosphites of the formula (I) (D) is comprised by the curable polyorganosiloxane and/or silane composition according to the invention. The one or more phosphites of the formula (I) exceeding the amount of phosphite present in complexed form in the compound (C) is either present due to the use of an excess of the phosphite of the formula (I) over a transition metal containing precursor compound when preparing the compound (C) in order to ensure full conversion of the transition metal-based precursor compound, or it is added in a sufficient amount in order to further retard the hydrosilylation reaction at room temperature in order to enable mixing of the components (A) to (C) as well as the dispensing and coating step without prior curing.

With respect to the component (D) it can be referred to the phosphites having the formula:

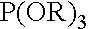

as defined above.

The one or more phosphites of the formula (I) (D) may be preferably incorporated therein in small amounts, such as less than 2 wt. % (20000 ppm) based on the total weight of (A) to (B). A particularly preferred range is 0.2 to 12000 ppm of component (D) related to (A) and (B).

Furthermore, preferably the molar ratio of the transition metal derived from component (C) platinum to the phosphite (D), including the phosphite complexed in the component (C), is from 1:1 to 1:6, preferably from 1:1.1 to 1:5, more preferably from 1:1.2 to 1:4.

Due to their interaction with the transition metal hydrosilylation catalyst compound, the component (D) acts as an inhibitor on the hydrosilylation reaction, thereby increasing storage stability, i.e. enlarge the pot-life, and at the same do not exert their inhibiting activity during curing reaction.

According to the invention, particularly preferred phosphites of the formula (I) constituting the component (D) are bis(2-tert-butyl-6-methyl-phenyl) ethyl phosphite, bis(2-tert-butyl-6-methyl-phenyl) methyl phosphite, bis(2,4-ditert-butyl-6-methyl-phenyl) ethyl phosphite and ethyl bis(2,4,6-tritert-butylphenyl)phosphite.

### Component (E):

The polyorganosiloxane and/silane composition according to the invention may comprise further ingredients (E) as auxiliary additives. The siloxane compositions according to the invention may also comprise further ingredients (E), by way of example conventional inhibitors, stabilizers, solvents, fillers, pigments or process aids added to achieve better process properties for the inventive polymer composition (A) to (C) or (A) to (D).

In general, auxiliary additives may serve the tuning of the processing time, the starting behavior and the curing rate of the curable composition.

As the case may be, it might be desirable to add additionally other conventional inhibitors, that is, to combine the inventive phosphites of component (D) with other conventional inhibitors in order to further modulate the hydrosilylation activity.

Thus, the inventive compositions may contain an appropriate amount of one or more additional conventional inhibitors. Preferably, however, the inventive compositions do not contain other phosphorous inhibitor compounds than those of formula (I).

Conventional inhibitors for the platinum group metal catalysts are well known in the organosilicon art. Examples of various classes of such metal catalyst inhibitors include unsaturated organic compounds such as ethylenically or aromatically unsaturated amides, U.S. Pat. No. 4,337,332; acetylenic compounds, U.S. Pat. Nos. 3,445,420 and 4,347,346; ethylenically unsaturated isocyanates, U.S. Pat. No. 3,882,083; olefinic siloxanes, U.S. Pat. No. 3,989,667; unsaturated hydrocarbon diesters, U.S. Pat. Nos. 4,256,870, 4,476,166 and 4,562,096, and conjugated eneynes. U.S. Pat. Nos. 4,465,818 and 4,472,563; other organic compounds such as hydroperoxides, U.S. Pat. No. 4,061,609; ketones, U.S. Pat. No. 3,418,731; sulfoxides, amines, nitriles, U.S. Pat. No. 3,344,111; diaziridines, U.S. Pat. No. 4,043,977; and various salts, such as U.S. Pat. No. 3,461,185, phosphorous compounds preferably excluded. Examples thereof include the acetylenic alcohols of U.S. Pat. No. 3,445,420, such as ethynylcyclohexanol and methylbutynol, 3,5-dimethyl-1-hexyn-3-ol and 3-Methyl-1-dodecin-3-ol, the unsaturated carboxylic esters of U.S. Pat. No. 4,256,870, such as diallylmaleate and dimethyl maleate; and the maleates and fumarates of U.S. Pat. Nos. 4,562,096 and 4,774,111, such as diethyl fumarate, diallyl fumarate and bis-(methoxyisopropyl) maleate. The half esters and amides of U.S. Pat. No. 4,533,575; and the inhibitor mixtures of U.S. Pat. No. 4,476,166 would also be expected to behave similarly. Further classes of inhibitors are trialkylcyanurates, organic hydroperoxides such as cumol hydroperoxide, tert-butyl hydroperoxide and pinane hydroperoxide, organic peroxides, organic sulfoxides, phosphanes, triazoles and oximes. The above-mentioned patents relating to conventional inhibitors for platinum group metal-containing catalysts are incorporated herein by reference.

If the compositions of the present invention optionally comprise solvents these solvents are usual organic solvents in the range of less than 20 wt.-%, preferably less than 10 wt.-% and most preferably less than 5 wt.-% related to (A) to (C) or (A) to (D). Appropriate reactive solvents can be selected from the group of olefinic hydrocarbons such as alpha-olefins, e.g. C₈-C₂₅-alpha-olefins, preferably C₁₄-C₂₀-alpha-olefins, or evaporable siloxanes having a molecular weight below 518 g/mol without alkenyl or SiH groups. Mixtures of alpha-olefins can also be used.

Other additives falling under definition of component (E) are selected from the group of heat stabilizers, coloring compounds or pigments, antioxidants, biocides, fungicides, such as Preventol®, Katon®, Dowicil®, fillers, especially spherical silsesquioxanes for getting additional antiblocking properties of release layers, anti-mist additives as disclosed in U.S. Pat. No. 6,586,535 or US 2003/0134043, anchorage additives, slipping agents as disclosed in EP 819735 A1 and further auxiliary components typical for silicone release compositions. These other ingredients may be contained in said reactive silicon-based composition in a total amount of up to 20 wt. %.

If fillers are used in inventive compositions the amount of filler is between 1 to 300 weight parts, preferably 15 to 80 weight parts related to 100 weight parts of component (A). The fillers are preferably selected from the groups of hydrophilic or hydrophobic, preferably surface-modified fillers. The fillers may serve as reinforcing fillers, thickening additive, as anti-blocking or anti-friction or matting additive.

The fillers include by way of example all of the fine-particle fillers, i.e. those having particles smaller than 100 μm (sieve residue), i.e. preferably composed of particles smaller than this value. The fillers in general may be non-reinforcing fillers, i.e. fillers with a BET surface of preferably up to 50 m²/g such as quartz, diatomaceous earth, calcium silicate, zirconium silicate, talcum, kaoline, zeolites, metal oxide powders, such as aluminum, titanium, iron, or zinc oxides and mixed oxides thereof, respectively, barium sulfate, calcium carbonate, gypsum, silicon nitride, silicon carbide, boron nitride, glass or polymer powders, such as polyacrylonitrile powder, or reinforcing fillers, i.e. fillers with a BET surface of more than m²/g, like precipitated chalk, carbon black, such as furnace carbon black and acetylene carbon black and silicon-aluminum mixed oxides with a large BET surface; aluminum trihydroxide, spherically formed fillers, such as ceramic microspheres, elastic polymer spheres or glass spheres; fibrous fillers, such as asbestos and polymer fibers. The fillers may be hydrophobized, for example by treatment with organosilanes or organosiloxanes, respectively, or by treatment with stearic acid, or by etherification of the hydroxyl groups to alkoxy groups.

Preferred are mineral fillers, such as silicates, carbonates, nitrides, oxides, carbon blacks, or silicas being fumed or precipitated silica, whose BET-surface areas are from 0.3 to 400 m²/g, these preferably having been specifically surface-hydrophobized here. Preferred silicas are, for example, Aerosil® 200, 300, HDK® N20 or T30, Cab-O-Sil® MS 7 or HS 5 more than 200 m²/g BET surface area or precipitated silicas, or wet silicas, are Vulkasil® VN3, or FK 160 from Degussa, or Nipsil® LP from Nippon Silica K.K. and others. Examples of commercially available silicas pre-hydrophobized with various silanes are: Aerosil® R 972, R 974, R 976, or R 812, or, for example, HDK® 2000 or HDK® H30, names for materials known as hydrophobized precipitated silicas or wet silicas are Sipernat® D10 or D15 from Degussa. Surface-treated fillers having low BET-values are preferred because the ability to build up shear thinning effects is reduced. The preferred surface treatment can be achieved with polyorganosiloxanediols, polyorganosiloxanes, alkoxy- or chlorosilanes, which allows a certain concentration of fillers having lowest degree of thickening properties and shear thinning. Another class of fillers serving as non-transparent non-reinforcing fillers are powdered quartz, diatomaceous earths, powdered crystobalites, micas, aluminum oxides, aluminum hydroxides, oxides and salts of Fe, Mₙ, Ti, Zn, Zr, chalks, or carbon blacks, whose BET-surface areas are from 0.3 to 50 m²/g.

These fillers are available under variety of trade names, examples being Sicron®, Min-U-Sil®, Dicalite®, Crystallite® and serve as matting agents. Such fillers are used if present in a concentration of about 1 to 300 weight parts, preferably 5 to 100 weight parts related to 100 weight parts of (A).

Some very special fillers can be used as matting agent, agent for increasing the mechanical modulus, or anti-blocking agent, these filler are selected from the group of spherical or fiber shaped thermoplastic powders or fibres such as PTFE-powders, PTFE-emulsions or polyamide, polyurethane or silsesquioxanes powders, thermoplastic fibers cured silicone elastomers or resins und are used if present in amounts of up to 10 weight parts related to 100 weight parts of (A). Tradenames are Teflon® emulsions, Nylon®-powders, Tospearl®, Acemat®, Twaron®, Kevlar®, Dralon®, Diolen® etc.

This type of filler especially if the particles have a spherical shape can preferably be used as anti-blocking agents in the release layer and can give an especially soft touch and low friction properties of the rubber surfaces.

Another class of additives are stabilizers, such as heat stabilizers which can be selected from the group of metal compounds, organic or inorganic salts, complexes of Ce, Fe, La, Mn, Ti and Zr.

Levelling agents, mold release agents are selected from the group consisting of polyether-siloxanes, polyols, polyethers, polyhalides, fatty alcohol or fluoroalkyl derivatives.

Another class of important auxiliary additives are adhesion promotors, which can either be incorporated in the composition (A) to (C) or (A) to (D), respectively, or applied in an appropriate form as primer applied prior onto the substrate foreseen for getting adhered to the rubber composition under curing.

Adhesion promotors are preferably selected from the group of alkoxysilanes, their condensation product alkoxysiloxanes bearing further organofunctional groups linked over Si—C-bonds, in particular epoxyalkyl, acryloxyalkyl, methacryloxyalkyl, NCO-alkyl, aminoalkyl, urethanealkyl, alkenyl which further can bear SiH groups. In line with this, the alkoxy silane serving as an adhesion promoter may further comprise an additional functional group that can interact with groups on a substrate, e.g. a plastic substrate. Thus, the alkoxy silane may further comprise a group such as, without being limited thereto, an epoxide, an ester, or an anhydride. Preferably, the ester is an ester of fumaric acid, succinic acid, or maleic acid. Also preferably, the anhydride is succinic anhydride, and the at least one alkoxy silane may comprise an ester or an anhydride group. The alkoxy silane may be selected from the group comprising glycidoxypropyl trimethoxy silane, bis(3-trimethoxysilylpropyl) fumarate, and (3-triethoxysilyl)propyl succinic anhydride. The adhesion promoters applied may also include at least two alkoxy silanes, and preferably they include at least two alkoxy silanes further comprising an additional functional group. The alkoxy silanes applied as adhesion promoters may also be selected from bis(3-trimethoxysilylpropyl) fumarate and/or (3-triethoxysilyl)propyl succinic anhydride.

Such silanes/siloxanes can be combined with condensation catalyst selected from the group of organometal compounds of Ca, Zr, Zn, Sn, Al or Ti and/or polycyclic aromatic compounds having reactive groups such as alkenyl substituted aromatic biphenyl ethers, esters. The effects of adhesion can be further improved by the addition of selected compounds of component (B), e.g. incorporated by reference U.S. Pat. Nos. 4,082,726, 5,438,094; 5,405,896; 5,536,803; 5,877,256; 6,602,551; EP 581504 A; and EP 875536.

According to the invention, particularly preferred auxiliary agents are
conventional inhibitors known for the application in hydrosilylation curable compositions, for example tris(2,4-ditert-butylphenyl)phosphite (Irgafos 168) or 1-ethinyl-1-cyclohexanol; the inhibitors are preferably present in a weight amount of 0-1000 ppm w/w related to the weight of the component (A), more preferably 0 to 800 ppm w/w, even more preferably 10 to 500 ppm w/w;
adhesion promoters, in particular alkoxysilanes, for example gamma-methacryloxypropyltrimethoxy silane, gamma-glycidoxypropyltrimethoxy silane, α,2,4,6,6,8-hexamethylcyclotetrasiloxanepropanoic acid 3-(trimethoxysilyl)propyl ester (CAS 113684-56-3); the adhesion promoters are preferably present in an amount of 0 to 5 parts by weight (pw) related to the weight of the component (A) constituting 100 parts by weight more preferably 0 to 3 parts by weight, even more preferably 0 to 2 parts by weight, and even further preferably 0 to 1 parts by weight;
fillers, preferably silica fillers, more preferably surface-modified silica fillers, for example Evonik Aerosil R8200 silica with a BET surface area of 155 m²/g hydrophobized with HMDZ; the fillers are preferably present in an amount of 0 to 200 parts by weight related to the weight of the component (A) constituting 100 parts by weight, more preferably 1 to 150 parts by weight, even more preferably 5 to 100 parts by weight, even more preferably 10 to 75 parts by weight, and still more preferably 20 to 50 parts by weight.

The curable polyorganosiloxane and/or silane compositions can be used for all purposes for which curable polyorganosiloxane and/or silane compositions have been used up to now in the art, such as coating and impregnation of any kind of substrate, the production of molded parts, for example by injection moulding, vacuum extrusion, extrusion, mould casting, compression moulding, for impressions, and as sealant, potting compound or casting compound.

The curable composition according to the invention is preferably used to coat a solid substrate, such as paper, fabrics or plastics, metal substrates such as metal foils, metal sheets and metal surfaces of articles, optionally with an adhesive-releasing layer or for extruding, calendering or molding shaped formed articles, laminates or for ‘Formed-In-Place’-sealing masses.

In an embodiment according to the invention, the curable polyorganosiloxane compositions and/or silane compositions according to the invention described above further comprises one or more phosphites of the formula (I) as defined above.

In addition to the phosphite of the formula (I), which is complexed by the transition metal of the transition metal compound of the invention, typically a minor excess of the phosphite of the formula (I) is present in the composition, as an excess of the phosphite of the formula (I) is used in the synthesis of the catalyst in order to obtain full conversion of the transition metal-containing precursor compound. According to the invention, one or more further phosphites of the formula (I) or excess of the phosphite of the formula (I) comprised by the transition metal compound of the invention may be further present in the curable polyorganosiloxane compositions and/or silane compositions as described above in order to enhance and modify the pot life and curing time of the transition metal catalyst due to the stabilizing and inhibiting properties of the additional phosphites of the formula (I).

In a preferred embodiment according to the invention, the transition metal of the transition metal compound comprised by the curable polyorganosiloxane compositions and/or silane compositions according to the invention is selected from the group consisting of nickel, ruthenium, rhodium, palladium, osmium, iridium, and platinum, preferably platinum.

In another embodiment according to the invention, the curable polyorganosiloxane compositions and/or silane compositions according to the invention comprise:
(A) one or more polyorganosiloxanes and/or silanes having in average at least two alkenyl groups,
(B) one or more polyorganosiloxanes and/or silanes having in average at least two SiH groups,
(C) one or more transition metal compounds, wherein the transition metal is selected from group consisting of nickel, ruthenium, rhodium, palladium, osmium, iridium, and platinum,
(D) optionally one or more phosphites of the formula (I) as defined above, and
(E) optionally one or more auxiliary agents.

Therein, the components (A) to (E) are as defined in the previously described embodiments.

Preferably, the one or more polyorganosiloxanes and/or silanes having in average at least two alkenyl groups (A) are selected from
dimethylvinylsilyl-terminated polydimethylsiloxanes of the general average composition of MVi₂Dₘ, wherein m is in the range of from 50 to 1500, preferably 300 to 1300, more preferably 400 to 1100, even more preferably 450 to 1000;
dimethylvinylsiloxy-terminated poly(dimethylsiloxane-co-methylvinylsiloxane) of the general average composition MVi₂DₙDViₒ, wherein n is in the range of from 1000 to 1000, preferably 200 to 900, more preferably 300 to 800, and even more preferably 400 to 700, and o is independently in the range of from 10 to 120, preferably in the range of 15 to 90, more preferably in the range of 20 to 70, even more preferably in the range of 25 to 50;
the one or more polyorganosiloxanes and/or silanes having in average at least two SiH groups (B) are independently selected from—hydride terminated poly(dimethylsiloxane)s of the general average composition MH₂Dₐ, wherein a is in the range of from 5 to 100, preferably from 8 to 80, more preferably in the range from 10 to 50, even more preferably in the range from 12 to 40, most preferably in the range from 13 to 25;
trimethylsilyl-terminated poly(dimethylsiloxane-co-methylhydrogensiloxane)s of the general average composition M₂D_{b}DH_{c}, wherein b is in the range of from 10 to 50, preferably 12 to 40, more preferably 14 to 40, even more preferably 15 to 30, and c is independently in the range of from 2 to 50, preferably 4 to 40, more preferably 6 to 40, even more preferably 8 to 30;
a resin type with a general average composition of MH_{dx}Qₓ, wherein d is in the range of 1.1 to 2.5, preferably in the range of 1.2 to 2.2, more preferably in the range of 1.3 to 2.1, and even more preferably in the range of 1.5 to 2.0;
trimethylsilyl-terminated polymethylhydrogensiloxanes with a general average composition of M₂DHₑ, wherein e is in the range of from 5 to 100, preferably 10 to 80, more preferably 15 to 60, even more preferably 20 to 40; or
trimethylsilyl-terminated poly(dimethylsiloxane-co-diphenylsiloxane-co-methylhydrogensiloxane)s with a general average composition M₂D(Ph₂)_{f}DH_{g}Dₙ, wherein f is in the range of from 1 to 50, preferably 1 to 40, more preferably 1 to 25, even more preferably from 1 to 15, g is independently in the range from 2 to 50, preferably 6 to 40, more preferably 12 to 30, and h is in the range of from 1 to 50, preferably 2 to 40, more preferably 3 to 25, even more preferably from 5 to 15;
the one or more transition metal compounds comprising a phosphite of the formula (I) (C) are preferably selected from {η⁴-(H₂C═CHSiMe₂)₂O}{bis(2-tert-butyl-6-methyl-phenyl) ethyl phosphite}platinum, {η⁴-(H₂C═CHSiMe₂)₂O}{bis(2-tert-butyl-6-methyl-phenyl) methyl phosphite}platinum, {η⁴-(H₂C═CHSiMe₂)₂O}{bis(2,4-ditert-butyl-6-methyl-phenyl) ethyl phosphite}platinum, and {η⁴-(H₂C═CHSiMe₂)₂O}{ethyl bis(2,4,6-tritert-butylphenyl)phosphite}platinum;

the optional one or more phosphites of the formula (I) (D) are, if present, preferably selected from bis(2-tert-butyl-6-methyl-phenyl) ethyl phosphite, bis(2-tert-butyl-6-methyl-phenyl) methyl phosphite, bis(2,4-ditert-butyl-6-methyl-phenyl) ethyl phosphite and ethyl bis(2,4,6-tritert-butylphenyl)phosphite;

the optional auxiliary agents (E) are preferably selected from
conventional inhibitors known for the application in hydrosilylation curable compositions such as organophosphites and acetylenic alcohols,
adhesion promoters, in particular alkoxysilanes
fillers, preferably silica fillers, more preferably surface-modified silica fillers, for example Evonik Aerosil R⁸²⁰⁰ silica with a BET surface area of 155 m²/g hydrophobized with HMDZ. Therein, the curable composition may comprise further components (D) or (E) than cited above.

Further preferably, the composition comprises one or more phosphites of the formula (I) (D) or one or more auxiliary agents (E), more preferably the composition comprises both one or more phosphites of the formula (I) (D) and one or more auxiliary agents (E).

In a more specific embodiment according to the invention, the curable polyorganosiloxane compositions and/or silane compositions according to any of the previous embodiments comprises:
100 pw of component (A),
0.1-200 pw, preferably 0.5 to 150 pw, more preferably 1 to 100 pw, even more preferably 1.5 to 75 pw, even further preferably 1.5 to 50 pw of component (B)
0.1-1000 ppm, preferably 0.2 to 750 ppm, more preferably 0.5 to 500 ppm, even more preferably 2 to 250 ppm, even further preferably 4 to 100 ppm of the transition metal contained in component (C) related to (A) and (B),
0.0 to 12000 ppm, preferably 0.2 to 12000 ppm of component (D) related to (A) and (B),
0 to 200 pw, preferably 1 to 150 pw, more preferably 5 to 100 pw, even more preferably 10 to 75 pw, even further preferably 20 to 50 pw, and still further preferably 20 to 45 pw of component (E).

The unit “ppm” refers, as indicated, to the total weight of the components (A) and (B) in the curable composition.

The unit “pw” indicates “parts by weight” and is used in such way that the weight of the component (A) present in the composition represents 100 parts by weight.

The amounts of the components (B) and (E) are thus indicated relative to the amount of component (A).

It is preferred according to this embodiment that the composition comprises 0.2 to 12000 ppm of the phosphite of the formula (I) (D). This component (D) is either present due to the addition of preformed and optionally purified transition metal compound (C), which may contain a residual amount of a phosphite of the formula (I) since usually an excess of the phosphite of the formula (I) over the transition metal-containing precursor compound used for the synthesis of the catalyst, or due to the formation of the compound (C) in situ in the curable composition, wherein usually also an 1.1 to 12-fold excess of the phosphite of the formula (I) is used in order to reach full conversion of the transition metal-containing precursor compound.

Further, one or more phosphite of the formula (I) may be added to the composition additionally in order to display an inhibiting effect.

In a further embodiment according to the invention, in the curable polyorganosiloxane compositions and/or silane compositions according to any of the previous and following embodiments, the molar ratio of platinum to the one or more phosphites of formula (I) is from 1:1 to 1:10 to avoid free platinum moieties.

In the ratio of the phosphites of the formula (I) and platinum moieties, both the phosphites of the formula (I) comprised by the transition metal compounds (C) and further additional phosphite of the formula (I) which is not in a state of complexation (D) is taken into consideration.

Preferably, the molar ratio of platinum to the one or more phosphites of formula (I) is from 1:1 to 1:8, more preferably from 1:1 to 1:5, even more preferably from 1:1 to 1:3, and most preferably from 1:1 to 1:2.

In a further embodiment according to the invention, in the curable polyorganosiloxane compositions and/or silane compositions as described before the phosphite of the formula (I) comprised by the transition metal compound is selected from

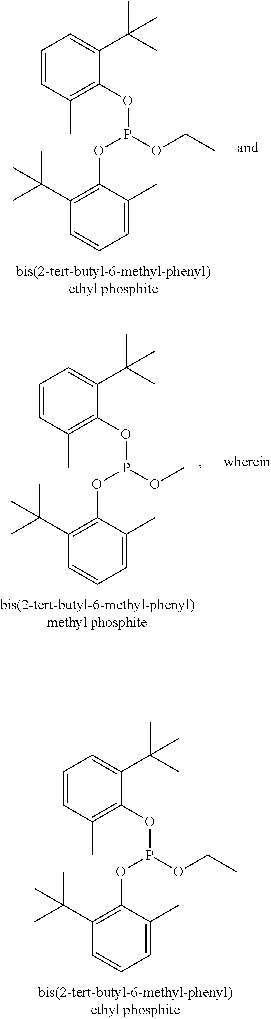

is preferred.

In a further embodiment according to the invention, in the curable polyorganosiloxane compositions and/or silane compositions,
the transition metal compound comprising a phosphite of the formula (I) comprises

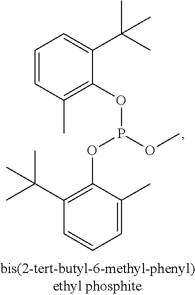 [SMILES: COP(Oc1c(C)cccc1C(C)(C)C)Oc1c(C)cccc1C(C)(C)C]

and the complex is a platinum complex.

Another aspect of the invention relates to the use of one or more phosphites of the formula (I) as defined in any of the previous embodiments for the manufacture of curable polyorganosiloxane and/or silane compositions.

The one or more phosphites of the formula (I) may be added directly to a polyorganosiloxane and/or silane composition before or after the addition of a transition metal pre-catalyst, or it may be used to form a transition metal compound which is then used for the manufacture of curable polyorganosiloxane and/or silane compositions.

Preferably, the transition metal compound comprising a phosphite of the formula (I) is formed beforehand and then added to the mixture of components to form the curable composition.

Still another aspect of the invention relates to the use of one or more phosphites of the formula (I) as defined in any of the previous embodiments as inhibitors of the hydrosilylation reaction in the curing of polyorganosiloxane compositions and/or silane compositions.

By the addition of one or more phosphites of the formula (I) to a curable composition comprising a transition metal compound serving as curing catalyst, at least a part of the curing catalyst is transformed to a transition metal compound comprising a phosphite of the formula (I) as ligand, which in most cases results in a decrease of reaction rate at least at low reaction temperatures, as it is a characteristic of said transition metal compounds to display a very low catalytic activity in hydrosilylation reactions at low temperatures. Thus, a prolonged pot-life is provided to compositions comprising such catalyst, high reaction rates are displayed at elevated temperatures, resulting in fast curing upon thermal activation. The decrease of catalytic activity at low temperatures resulting in prolonged pot-life of the curable compositions is considered to be an inhibiting effect of the phosphites of the formula (I) according to the invention.

A further aspect of the invention relates to one-part curable polyorganosiloxane and/or silane compositions comprising one or more phosphites of the formula (I) as defined in any of the previous embodiments.

Under the expression ‘One-Part’-hydrosilylation-curing polyorganosiloxane and/or silane compositions it is meant in accordance with the present invention, that the curable composition as described in the embodiments according to the invention, in particular a composition comprising the component (A) to (C) and optionally (D) and/or (E), comprises all ingredients to get cured under the appropriate conditions, in particular at an increased temperature level of higher than 25° C., preferably higher than 40° C., more preferably higher than 70° C., even more preferably higher than 80° C., and most preferably higher than 90° C.

For the preparation of a one-part curable polyorganosiloxane and/or silane composition, the components of such composition, preferably the components (A) to (E) as defined above, are mixed first to non-reactive compositions, that is compositions which do not contain polyorganosiloxanes and/or silanes having one or more alkenyl groups, preferably two or more alkenyl groups, polyorganosiloxanes and/or silanes having one or more SiH groups, preferably two or more SiH groups, and a transition metal compound capable of catalyzing hydrosilylation reactions at the same time.

The curable compositions according to the invention have a very high stability, i.e. a very long storage time.

In still a further aspect according to the invention, it relates to a two-part curable polyorganosiloxane and/or silane composition comprising one or more phosphites of the formula (I) as described in the embodiments according to the invention.

Such two-part curable compositions are prepared and supplied based on two compositions, wherein each partial composition does not contain all of the components (A) to (C) as previously defined. Those partial compositions can be stored practically for more than 100 days. The manufacturer usually prepares the reactive composition by mixing of the partial compositions. The reactive curable composition has then still a storage stability of more than 30 days.

Accordingly, the present invention also relates to the partial composition comprising components (A)+ (C)+optionally (D)+optionally (E).

Such partial composition requires the addition of one or more polyorganosiloxanes and/or silanes having in average at least two SiH groups (B) in order to arrive at curable polyorganosiloxane compositions and/or silane compositions as defined above.

The present invention also relates to the partial composition comprising components (A)+ (B)+optionally (D)+optionally (E), which requires the addition of the component (C) to arrive at curable compositions as defined above, and to partial composition comprising components (B)+ (C)+optionally (D)+optionally (E), which requires the addition of the component (A) to arrive at curable compositions as defined above.

In particular, the invention comprises a set of two partial compositions as described above which upon mixing the partial compositions form a curable polyorganosiloxane and/or silane composition comprising the components (A), (B), (C), optionally (D) and optionally (E), preferably the components (A), (B), (C), (D) and (E) as described above.

The two-part curable compositions can be cured in the temperature range of from 20° C. to 250° C., preferably from 80° C. to 130° C., more preferably from 80° C. to 120° C., and they have a pot life of at least 48 hours.

It is also within the scope of the invention that the curable composition is prepared and supplied based on three compositions.

In the selection of the components (A), (B), (C) and optionally (D) and/or (E), the same compounds are preferred as described with regard to the embodiments of the curable composition presented above; likewise, the same amounts by weight and weight ratios as discussed above are preferably used when the components are combined first in partial compositions.

Another aspect of the invention relates to cured polyorganosiloxane and/or silane compositions obtained by curing the curable polyorganosiloxane and/or silane compositions as defined in any of the embodiments according to the invention described above.

Preferably, the cross-linking of the compositions according to the invention in order to obtain a cured composition is performed at a pressure of 30 to 25000 hPa, in particular at ambient pressure of 900 to 1100 hPa, or at a pressure common in injection moulding machines of 100000 to 250000 hPa.

Preferably, the curing temperature for the curable compositions of the invention is above 25° C., more preferably above 50° C., even more preferably above 70° C., still further preferably above 80° C., and most preferably above 90° C.

The cured polyorganosiloxane and/or silane compositions can be used for all purposes for which cured polyorganosiloxane and/or silane compositions have been used up to now in the art, such as coating and impregnation of any kind of substrate, the production of molded parts, for example by injection moulding, vacuum extrusion, extrusion, mould casting, compression moulding, for impressions, and as sealant, potting compound or casting compound.

Further, the invention relates to the use of the curable polyorganosiloxane compositions and/or silane compositions as defined in any of the previous embodiments for the manufacture of shaped formed articles, extruded articles, coatings, and sealants.

Depending on the viscosity of the components of the curable polyorganosiloxane compositions and/or silane compositions according to the invention and the filler content, the curable compositions may be of low viscosity and pourable, have a paste-like consistency, be a powder, or a smooth highly viscous mass. Likewise, the elastomeric properties of the cured compositions according to the invention comprise the full spectrum starting with extremely soft silicone gels, covering gum-like materials and spanning up to highly cross-linked silicones with glass-like properties. Accordingly, the curable compositions according to the invention may be beneficially applied in a number of applications.

In particular in the manufacture of shaped articles formed under extrusion there is an increasing demand for curing such rubber articles via a hydrosilylation reaction while replacing peroxides. The cure rates necessary for such technology are rather high i.e. the cure time is short, and is in general below 3 min at 110° C. in order to get a bubble free cured elastomeric article. These requirements s can be achieved with the hydrosilylation-curing polyorganosiloxane and/or silane compositions according to the invention. At the same time the hydrosilylation-curing polyorganosiloxane and/or silane compositions according to the invention have storage stability at 25° C. of preferably more than 2 days.

The term storage stability used in accordance with the present invention means the t₁₀-time at 25° C., which is the time wherein 10% of the elastic modulus of the fully cured material at 25° C. is reached, after preparation of the reactive composition. On the other hand, the cure time of the hydrosilylation-curing polyorganosiloxane and/or silane compositions is the time too at 110° C., which is the time wherein 90% of the elastic modulus of the fully cured material at 110° C. is reached after preparation of the reactive composition. The elastic modulus is measured with a Rheometer MDR 2000 of Alpha Technologies.

Another important application of the hydrosilylation-curing polyorganosiloxane and/or silane compositions according to the invention are siloxane coatings e.g. release coatings for plastics which must be cured below 110° C. within a reasonable short curing time given by the band speed of the coating machines which is usually between 50-1000 m/min whereby the coating thickness is usually between 0.05-1 mm.

A further aspect of the invention relates to a process for the manufacture of the curable polyorganosiloxane compositions as defined in any of the previous embodiments, comprising mixing
(A) one or more polyorganosiloxanes and/or silanes having in average at least two alkenyl groups,
(B) one or more polyorganosiloxanes and/or silanes having in average at least two SiH groups,
(C) one or more transition metal compounds, wherein the transition metal is selected from group consisting of nickel, ruthenium, rhodium, palladium, osmium, iridium, and platinum,
(D) optionally one or more phosphites of the formula (I), and
(E) optionally one or more auxiliary agents
in a mixing apparatus.

According to the invention, the manufacture of the curable composition is achieved by mixing said components in any order, using any method or mixing process known in the art.

Preferably, the mixing takes place at 10° C. to 130° C. under a pressure of 30 to 1100 hPa, more preferably at a reduced pressure of 30 to 500 hPa, or at an atmospheric pressure of 900 to 1100 hPa.

The process according to the invention may be performed continuously or discontinuously, i.e. batch-wise.

According to the invention, in the manufacture of the curable composition the transition metal compound (C) is uniformly mixed with a mixture of the components (A) and (B) and, optionally, (D) and (E).

The transition metal compound (C) may be added in substance or as a solution in a suitable solvent, or as a so-called batch, which means in a uniform mixture with a low amount of (A) or (A) and (E).

The curable compositions according to the invention may be either one-part compositions or two-part compositions. In the latter case, both parts may comprise all components in any ratio, preferably the part containing the transition metal compound (C) does not comprise any Si—H-comprising component, e.g. component (B).

In the preparation of a one-part composition, the components (A) to (E) are mixed first to non-reactive compositions, that is, compositions which do not contain (A), (B) and (C) at the same time.

It is in practice preferred to prepare and supply two or three partial compositions, wherein each partial composition does not contain all of the components (A) to (E). Those partial compositions can be stored practically for more than 100 days. The manufacturer usually prepares the reactive composition by mixing of the partial compositions. The reactive composition has then still a storage stability of more than 2 days.

Those preferred partial compositions are most preferably two partial compositions containing the following components:
(A)+ (B)+optionally (D)+optionally (E), e.g. fillers;
(A)+ (C)+optionally (E), e.g. fillers.

Such a combination of the partial compositions is preferred because a 1:1 mixture per volume is achievable, which is easily to be mixed by static mixers. Another advantage of such a combination of partial compositions is the avoidance of the simultaneous presence of (B) and (C) which detrimental because of a possible occurrence of discolouration. On the other hand the combination of (A) and (C) has a stabilizing effect on the transition metal catalyst component (C).

The partial compositions as defined before are preferably prepared for example with in a mixing apparatus selected from kneaders, dissolvers, extruders, LIST-mixing apparatuses, BUSS-co-kneader, Banbury mixers or ‘press-mixers’ of Voith, or two roll-mixers.

The reactive ‘One Part’-compositions are preferably prepared by mixing the partial compositions by mixing the with them for example in a mixing apparatus selected from static mixers, kneaders, like two blade kneaders, dissolvers, extruders, LIST-mixing apparatuses, BUSS-co-kneader, Banbury mixers or ‘press-mixers’ of Voith, two roll-mixers, or multi roll coating mixtures.

Accordingly, the present invention also relates to the partial composition comprising components (A)+ (B)+optionally (D)+optionally (E).

### Preferred Compositions:

The inventive compositions preferably applied as ‘Two-Part’-composition can be used preferably as a so-called paper release coating, gels as a liquid rubber or as a high consistency rubber composition having optionally incorporated reinforcing fillers, which for example have the following composition:

(A) 100 pw. of one or more polyorganosiloxanes and/or silanes having in average at least two alkenyl groups and a viscosity of 50 mPa·s⁻¹⁰⁰ kPa·s at 25° C.,
(B) 0.1 to 100 of one or more polyorganosiloxanes and/or silanes having in average at least two SiH groups in an amount to achieve a molar ratio of SiH:Si-alkenyl groups of 0.8 to 6:1,
(C) 1-500 ppm calculated as metal related to (A) and (B) of one or more transition metal compounds comprising a phosphite of the formula (I), wherein the transition metal is selected from group consisting of nickel, ruthenium, rhodium, palladium, osmium, iridium, and platinum,
(D) optionally one or more phosphites according to formula (I) preferably in an amount to achieve a molar ratio of 1:1 to 10:1 of phosphites of the formula (I) not being in a state of complexation to a transition metal and phosphites being comprised by a transition metal compound to the metal atom of component (C), and
(E) 0-200 pwt. of one or more reinforcing silicas having a BET-surface of more than 50 m²/g and optionally further auxiliary additives.

### Summary of Preferred Embodiments

In the following, the preferred embodiments of the invention are summarized:
1. A transition metal compound, comprising at least one phosphite compound of the formula

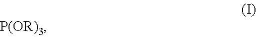

wherein
R represents an organic group, and wherein at least one group R is represented by the formula (II)

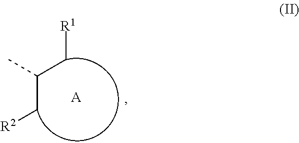

wherein
the ring denoted by A represents an aromatic or heteroaromatic group, which may have one or more further substituents apart from R¹ and R²,
the dotted line represents a single bond to the oxygen atom of the phosphite compound of formula (I),
R¹ and R² each represent substituents in the ortho-position of said aromatic or heteroaromatic group relative to the oxygen atom of the phosphite compound of formula (I), and
wherein said substituents R¹ and R² are each independently selected from the group consisting of an optionally substituted aliphatic group, in particular optionally substituted alkyl groups and optionally substituted alkenyl groups, and an optionally substituted aliphatic bridging group that forms a condensed ring system with another atom of the aromatic or heteroaromatic group corresponding to the ring denoted by A, alkoxy groups, alkoxycarbonyl groups and Si-organic groups,
and wherein at least two groups R are different from each other.
2. A transition metal compound according to any of the previous embodiments, wherein the transition metal compound is different from
Pt complexes comprising the phosphine of the formula

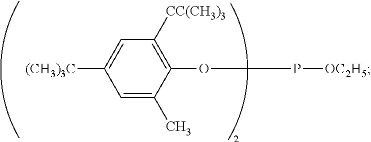

the Rh complexes of the formulas

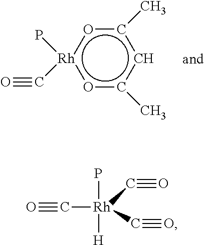

wherein the ligand P represents the structure

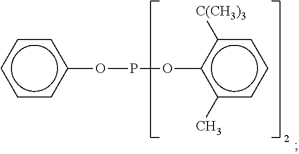

Rh, Pd and Pt complexes comprising phosphites of the formula

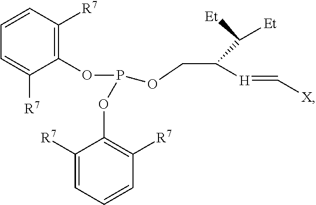

wherein R⁷ is methyl and X is a ferrocenyl group,
or R⁷ is methyl and X is a cymantrenyl group,
or R⁷ is isopropyl and X is a ferrocenyl group;
the Ni complex of the formula

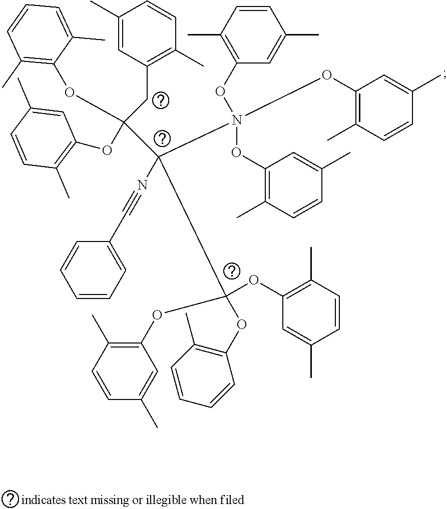

and preferably the transition metal compound is different from
Pt complexes comprising the phosphite of the formula

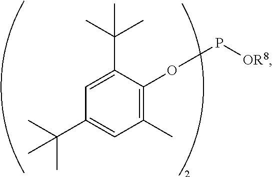

wherein R⁸ is a monovalent organic group having 1 to 5 carbon atoms;
and/or the transition metal compound is preferably different from
transition metal complexes comprising the ligand of the structural formula

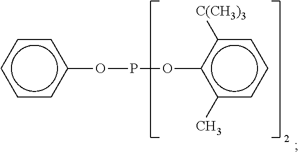

and/or the transition metal compound is preferably different from
transition metal complexes comprising a ligand of the structural formula

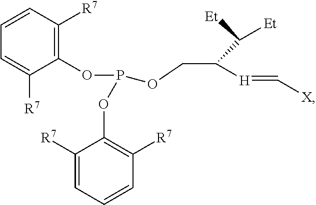

wherein R⁷ is methyl and X is a ferrocenyl group,
or R⁷ is methyl and X is a cymantrenyl group,
or R⁷ is isopropyl and X is a ferrocenyl group;
and/or the transition metal compound is preferably different from
transition metal complexes comprising a ligand of the structural formula

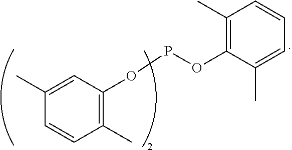

3. A transition metal compound according to embodiment 1 or 2, comprising at least one phosphite having the formula (III):

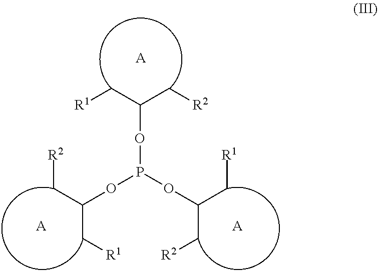

wherein at least two of the groups of the formula (II):

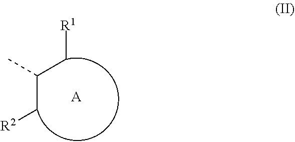

are different groups.
4. A transition metal compound according to any of the previous embodiments, wherein in formula (I) at least one group R is an organic group different from the group of formula (II).
5. A transition metal compound according to embodiments 1 or 3, comprising at least one phosphite selected from the group consisting of the formulae (IV) or (V):

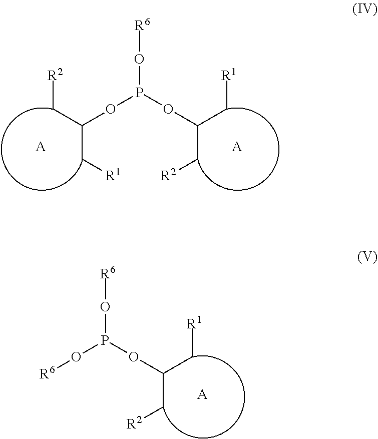

wherein in formula (IV) the groups of the formula (II):

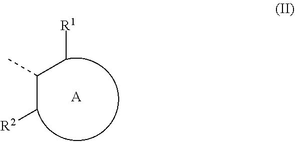

are the same or different groups, and preferably are the same groups, and
are in both formulae (IV) or (V) as defined above, and
wherein the groups R⁶ in formula (V) are the same or different groups, and preferably the groups R⁶ are the same groups, and the groups R⁶ are in both formulae (IV) or (V) selected from organic groups different from those of formula (II), and are preferably selected from optionally substituted aliphatic groups, such as optionally substituted alkyl or optionally substituted cycloalkyl groups.
6. A transition metal compound according to any of the previous embodiments, wherein the ring denoted by “A” in at least one group represented by formula (II) is an aromatic group, which optionally may have one or more further substituents apart from R¹ and R².
7. A transition metal compound according to any of the previous embodiments, wherein the ring denoted by “A” in at least one group represented by formula (II) is a phenyl group, which optionally may have one or more further substituents apart from R¹ and R².
8. A transition metal compound according to any of the previous embodiments, wherein the groups R¹ and R² are each optionally substituted linear, branched or cyclic alkyl groups, preferably having up to 10 carbon atoms, more preferably up to 6 carbon atoms.
9. A transition metal compound according to any of the previous embodiments, wherein the phosphites of formula (I) are selected from the compounds of formula (VI):

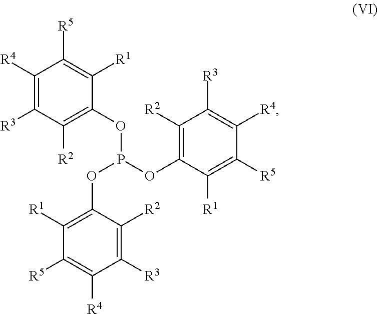

or selected from compounds of the formula (VII),

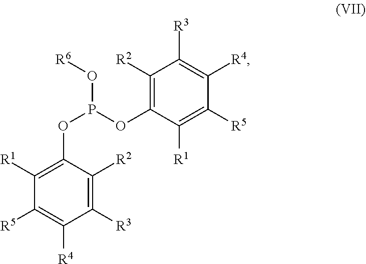

wherein in formulae (VI) and (VII) R¹, R² and R^{e} are each as defined above, and R³, R⁴, and R⁵ are each independently selected from hydrogen, halogen, cyano, nitro, Si-organic and organic groups, preferably optionally substituted aliphatic groups, and wherein in formulae (VI) at least two of the substituent groups:

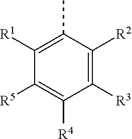

wherein the dotted line represents a single bond to the oxygen atom of the phosphite compound of the formula (I) are different from each other, and wherein in formula (VII) the two substituent groups

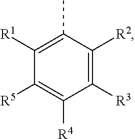

wherein the dotted line represents a single bond to the oxygen atom of the phosphite compound of the formula (I) are preferably the same.
10. The transition metal compound according to any of the previous claims, wherein the phosphites of the formula (I) are monodentate ligands.
11. A transition metal compound according to any of the previous embodiments, wherein in the phosphites of the formula (I) the groups R do not contain any metal atoms.
12. A transition metal compound according to any of the previous embodiments, wherein the groups R do not contain any nitrogen atoms.
13. A transition metal compound according to any of the previous embodiments, wherein the groups R do not comprise any groups containing N or P atoms, preferably do not comprise any groups containing N, P, S or Se atoms, and most preferably not comprising any groups containing N, P, S, Se or O atoms.
14. A transition metal compound according to any of the previous embodiments, wherein the groups R of the phosphites of the formula (I) can only contain C, H, O atoms and halogen atoms, wherein the O atoms can only be present in ether bonds or in ester groups, preferably the groups R can only contain C, H and halogen atoms, and most preferably the groups R in the phosphites of the formula (I) consist of C and H atoms.
15. A transition metal compound according to any of the previous embodiments, wherein the phosphites of formula (I) are selected from

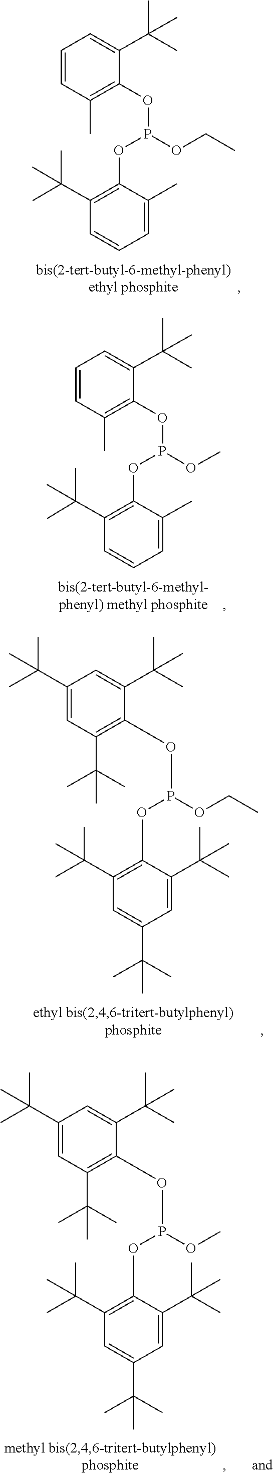

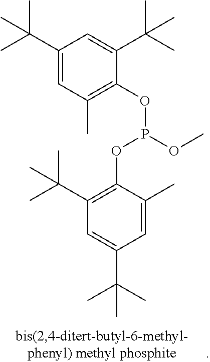 [SMILES: COP(Oc1c(C)cc(C(C)(C)C)cc1C(C)(C)C)Oc1c(C)cc(C(C)(C)C)cc1C(C)(C)C]

16. A transition metal compound according to any of the previous embodiments, wherein the phosphite compound of the formula (I) of the transition metal compound is selected from

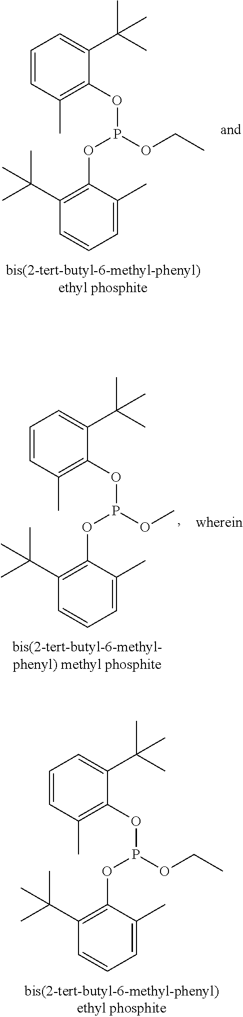

is preferred.
17. A transition metal compound according to any of the previous embodiments, wherein the transition metal of the transition metal compound is selected from the group consisting of nickel, ruthenium, rhodium, palladium, osmium, iridium, and platinum.
18. A transition metal compound according to any of the previous embodiments, wherein the transition metal is platinum, and preferably the phosphite compound of the formula (I) of the transition metal compound is

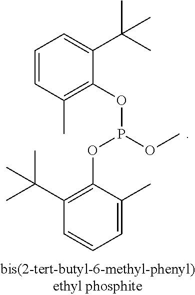 [SMILES: COP(Oc1c(C)cccc1C(C)(C)C)Oc1c(C)cccc1C(C)(C)C]

19. A transition metal compound according to any of the previous embodiments, wherein the transition metal compound is a transition metal complex compound wherein the transition metal has the oxidation state zero (0), preferably the transition metal complex compound is Pt (0)-compound.
20. A transition metal compound according to any of the previous embodiments, comprising one or more alkenyl ligands.
21. A transition metal compound according to any of the previous embodiments, comprising one or more alkenyl siloxane ligands.
22. A transition metal compound according to any of the previous embodiments of the formula:

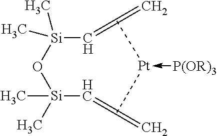

wherein P(OR)₃ is a phosphite of formula (I) as defined above.
23. Use of the transition metal compound comprising a phosphite of the formula (I) as defined in any of the previous embodiments as a curing catalyst for curable polyorganosiloxane compositions and/or silane compositions.
24. Curable polyorganosiloxane compositions and/or silane compositions, comprising one or more transition metal compounds comprising a phosphite of the formula (I) as defined above.
25 Curable polyorganosiloxane compositions and/or silane compositions according to embodiment 24, further comprising one or more phosphites of the formula (I) as defined above.
26. Curable polyorganosiloxane compositions and/or silane compositions according to the previous embodiments 24 and 25, wherein the transition metal is selected from group consisting of nickel, ruthenium, rhodium, palladium, osmium, iridium, and platinum, preferably platinum.
27. Curable polyorganosiloxane compositions and/or silane compositions according to the previous embodiments 24 to 26, comprising:
(A) one or more polyorganosiloxanes and/or silanes having in average at least two alkenyl groups,
(B) one or more polyorganosiloxanes and/or silanes having in average at least two SiH groups,
(C) one or more transition metal compounds comprising a phosphite of the formula (I), wherein the transition metal is selected from group consisting of nickel, ruthenium, rhodium, palladium, osmium, iridium, and platinum,
(D) optionally one or more phosphites of the formula (I) as defined above, and
(E) optionally one or more auxiliary agents.
28. Curable polyorganosiloxane compositions and/or silane compositions according to any of the previous embodiments 24 to 27, comprising:
100 pw of component (A),
0.1-200 pw of component (B)
0.1-1000 ppm of the transition metal contained in component (C) related to (A) and (B),
0.0 to 12000 ppm of component (D) related to (A) and (B),
0 to 200 pw of component (E).
29. Curable polyorganosiloxane compositions and/or silane compositions according to any of the previous embodiments 24 to 28, wherein the molar ratio of platinum to the one or more phosphites of formula (I) is from 1:1 to 1:10.
30. Curable polyorganosiloxane compositions and/or silane compositions according to the previous embodiments 24 to 29,
wherein the transition metal compound comprising a phosphite of the formula (I)
   comprises

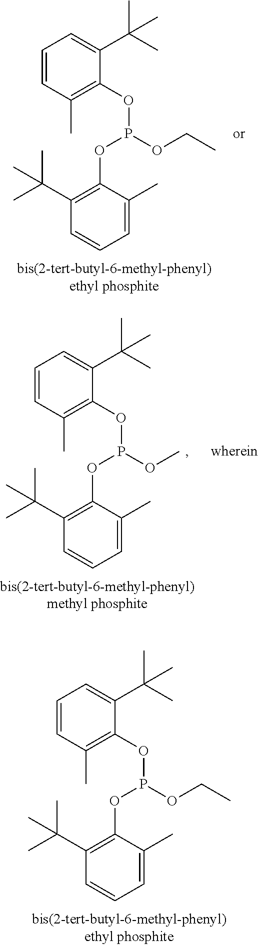

is preferred.
31. Curable polyorganosiloxane compositions and/or silane compositions according to the previous embodiments 24 to 30,
   wherein the transition metal compound comprising a phosphite of the formula (I) comprises

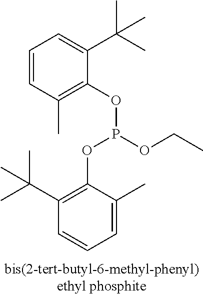 [SMILES: CCOP(Oc1c(C)cccc1C(C)(C)C)Oc1c(C)cccc1C(C)(C)C]

and the complex is a platinum complex.
32. Use of one or more phosphites of the formula (I) as defined in any of the previous embodiments for the manufacture of curable polyorganosiloxane and/or silane compositions.
33. Use of one or more phosphites of the formula (I) as defined in any of the previous embodiments as inhibitors of the hydrosilylation reaction in the curing of polyorganosiloxane compositions and/or silane compositions.
34. One-part curable polyorganosiloxane and/or silane compositions, comprising one or more phosphites of the formula (I) as defined in any of the previous embodiments.
35. Two-part curable polyorganosiloxane and/or silane compositions, comprising one or more phosphites of the formula (I) as defined in any of the previous embodiments.
36. Cured polyorganosiloxane and/or silane compositions obtained by curing the curable polyorganosiloxane and/or silane compositions as defined in any of the previous embodiments.
37. Use of the curable polyorganosiloxane compositions and/or silane compositions as defined in any of the previous embodiments for the manufacture of shaped formed articles, extruded articles, coatings, and sealants.
38. A process for the manufacture of the curable polyorganosiloxane compositions as defined in any of the previous embodiments, comprising mixing
(A) one or more polyorganosiloxanes and/or silanes having in average at least two alkenyl groups,
(B) one or more polyorganosiloxanes and/or silanes having in average at least two SiH groups,
(C) one or more transition metal compounds, wherein the transition metal is selected from group consisting of nickel, ruthenium, rhodium, palladium, osmium, iridium, and platinum,
(D) optionally one or more phosphites of the formula (I), and
(E) optionally one or more auxiliary agents
in a mixing apparatus.

### EXAMPLES

### a) Manufacture of the Phosphites

### 1. General Procedure

The phosphites of formula (I) have been synthesized according to the following general reaction scheme

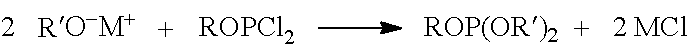

wherein
R′═R which is defined as in the embodiments, with the groups R′ and R being different from each other, and
M being Li or Na,
wherein ROPCl₂ is obtained from the reaction of PCI₃ and the corresponding metal oxide RO⁻ M⁺ and the metal alkoxides R′O⁻M⁺ and RO⁻M⁺ are obtained from a reaction of the corresponding phenol with sodium hydride or n-butyl lithium undergo a reaction in dried tetrahydrofuran (see also A. Earnshaw, N. Greenwood (1997): The Chemistry of the Elements—Second Edition).

A solution of the alcohol R′OH in THF (tetrahydrofuran), which has been dried, was added dropwise under vigorously stirring under a dry argon atmosphere to a suspension of NaH dissolved in THF or n-butyl lithium dissolved in hexane at 6° C. After the indicated period of stirring at room temperature, the phosphorous dichloride ROPCl₂ was added dropwise in THF. After addition, the mixture was stirred for further two hours at 40° C. Then hexane was added the evolved solid was removed by filtration. The filtrate was removed from the solvent and to the remaining raw product hexane was added. The resulting solution was flash filtered through an aluminium oxide column to yield the purified phosphite ROP(OR′)₂.

### 2. Specific Phosphites Prepared

### 2.1. Bis(2-tert-butyl-6-methyl-phenyl) ethyl phosphite (Inventive)

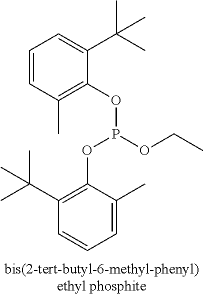 [SMILES: CCOP(Oc1c(C)cccc1C(C)(C)C)Oc1c(C)cccc1C(C)(C)C]

A solution of 10.37 g (63 mmol) 2-tert-butyl-6-methylphenol and 50 ml of dry THF was added dropwise to a suspension of 2.35 g NaH (59 mmol) in 25 ml THF at 0° C. and stirred for 60 minutes under nitrogen. Afterwards, 4.23 g (29 mmol) ethyldichlorophosphite (or dichloro(ethoxy)phosphane)):

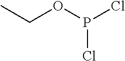

in THF was added over 10 minutes at 0° C. and under nitrogen atmosphere. After the addition was completed, the temperature was raised to 40° C. and it was stirred for further 2 h. The reaction mixture was then allowed to cool down to room temperature, 15 ml hexane was added, and the residue was filtered off. The solvent was evaporated from the filtrate, and the residue was dissolved in 10 ml n-Hexane. The solution was filtered then through an aluminium oxide flash column to purify the phosphite. The solvent was evaporated to yield 20.26 g (80%) of a slightly yellowish oil.

NMR data:

(¹H-NMR (400 MHZ, CDCl₃, 300 K); ³¹P NMR (121.47 MHZ, CDCl₃, 300 K)

| ³¹P | | ¹H | |
|---|---|---|---|
| ppm | Pattern | ppm | Pattern |
| 144.2 | s | 1.00 | t |
| | | 1.53 | s |
| | | 2.45 | d |
| | | 3.91 | dq |
| | | 6.98 | t |
| | | 7.07 | dd |
| | | 7.27 | dd |

### 2.2. Bis(2-tert-butyl-6-methyl-phenyl) methyl phosphite

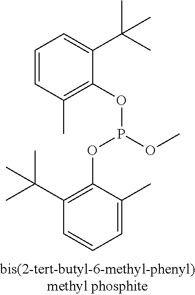 [SMILES: COP(Oc1c(C)cccc1C(C)(C)C)Oc1c(C)cccc1C(C)(C)C]

Bis(2-tert-butyl-6-methyl-phenyl) methyl phosphite was prepared as in example 2.1. using methyldichlorophosphite (or dichloro(mthoxy)phosphane) instead of ethyldichlorophosphite (or dichloro(ethoxy)phosphane)).

NMR data:

(¹H-NMR (400 MHZ, CDCl₃, 300 K); ³¹P NMR (121.47 MHZ, CDCl₃, 300 K)

| ³¹p | | ¹H | |
|---|---|---|---|
| ppm | Pattern | ppm | Pattern |
| 142.6 | s | 1.57 | s |
| | | 2.48 | d |
| | | 3.65 | d |
| | | 7.03 | t |
| | | 7.12 | dd |
| | | 7.33 | dd |

### 2.3. Bis(2,4-ditert-butyl-6-methyl-phenyl) ethyl phosphite (Comparative)

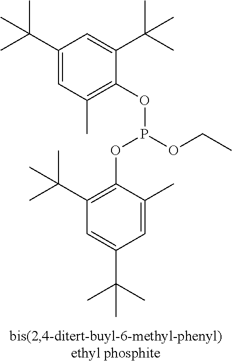 [SMILES: CCOP(Oc1c(C)cc(C(C)(C)C)cc1C(C)(C)C)Oc1c(C)cc(C(C)(C)C)cc1C(C)(C)C]

was commercially available as Irgafos 38 from BASF.

NMR data:

(¹H-NMR (400 MHZ, CDCl₃, 300 K); ³¹P NMR (121.47 MHZ, CDCl₃, 300 K))

| ³¹p | | ¹H | |
|---|---|---|---|
| ppm | Pattern | ppm | Pattern |
| 143.8 | s | 0.93 | t |
| | | 1.29 | s |
| | | 1.47 | s |
| | | 2.38 | d |
| | | 3.88 | dq |
| | | 7.02 | d |
| | | 7.24 | d |

### 2.4. Ethyl bis(2,4,6-tritert-butylphenyl)phosphite (Inventive)

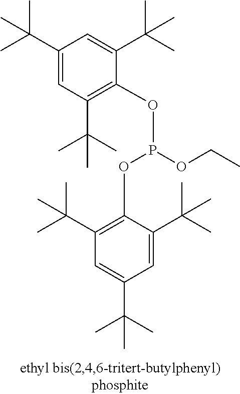 [SMILES: CCOP(Oc1c(C(C)(C)C)cc(C(C)(C)C)cc1C(C)(C)C)Oc1c(C(C)(C)C)cc(C(C)(C)C)cc1C(C)(C)C]

Ethyl bis(2,4,6-tritert-butylphenyl)phosphite was prepared starting from ethyldichlorophosphite (or dichloro(ethoxy)phosphane)) and 2,4,6-tritert-butylphenol as described under 2.1. before.

NMR data:

(¹H-NMR (400 MHZ, CDCl₃, 300 K); ³¹P NMR (121.47 MHz, CDCl₃, 300 K))

| ³¹P | | ¹H | |
|---|---|---|---|
| ppm | pattern | ppm | Pattern |
| 153.4 | s | 0.63 | t |
| | | 1.27 | s |
| | | 1.47 | s |
| | | 3.20 | dq |
| | | 7.30 | s |

### 2.5 Tris(2,4-ditert-butylphenyl)phosphite (Comparative)

Tris(2,4-ditert-butylphenyl)phosphite:

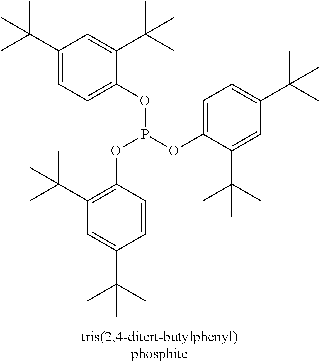 [SMILES: CC(C)(C)c1ccc(OP(Oc2ccc(C(C)(C)C)cc2C(C)(C)C)Oc2ccc(C(C)(C)C)cc2C(C)(C)C)c(C(C)(C)C)c1]

was commercially available as Irgafos 168.

### 2.6 Bis(2,4-ditert-butyl-5-methyl-phenyl) ethyl phosphite (Comparative)

Bis(2,4-ditert-butyl-5-methyl-phenyl) ethyl phosphite:

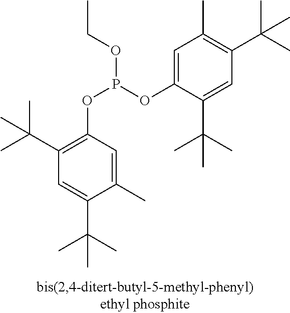 [SMILES: CCOP(Oc1cc(C)c(C(C)(C)C)cc1C(C)(C)C)Oc1cc(C)c(C(C)(C)C)cc1C(C)(C)C]

was prepared from ethyldichlorophosphite (or dichloro(ethoxy)phosphane) and 2,4-ditert-butyl-5-methyl-phenol in a similar manner as described in phosphite example 2.1. above.

### 2.7 Bis(2-allyiphenyl) ethyl phosphite (Comparative)

Bis(2-allylphenyl) ethyl phosphite:

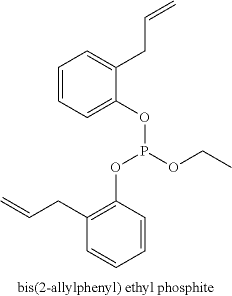 [SMILES: C=CCc1ccccc1OP(OCC)Oc1ccccc1CC=C]

was prepared from ethyldichlorophosphite (or dichloro(ethoxy)phosphane)) and 2-allylphenol in a similar manner as described in phosphite example 2.1, above.

### 2.8 3,9-Bis(2,4-ditert-butylphenoxy)-2,4,8,10-tetraoxa-3,9-diphosphaspiro[5.5]undecane (Comparative)

3,9-Bis(2,4-ditert-butylphenoxy)-2,4,8,10-tetraoxa-3,9-diphosphaspiro[5.5]undecane

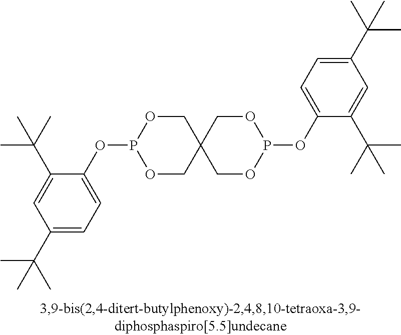 [SMILES: CC(C)(C)c1ccc(OP2OCC3(CO2)COP(Oc2ccc(C(C)(C)C)cc2C(C)(C)C)OC3)c(C(C)(C)C)c1]

was commercially available as Irgafos 126.

### B) Manufacture of the Transition Metal Compounds

### 1. General Procedure

Platinum phosphite catalyst complexes were synthesized in a standardized procedure. Pt Catalyst and phosphite, and a divinyl polymer with 10.000 mPas were dissolved in toluene and reacted at 80° C. for 30 minutes in a flask under N₂ atmosphere. Afterwards the toluene was completely removed by distillation to obtain the catalyst complex in quantitative yields with respect to Pt amount.

### 3. Catalyst Examples

### 3.1. Catalyst Example 1 (Inventive Catalyst)

### {η⁴—(H₂C═CHSiMe₂)₂O}bis(2-tert-butyl-6-methyl-phenyl) ethyl phosphite}platinum

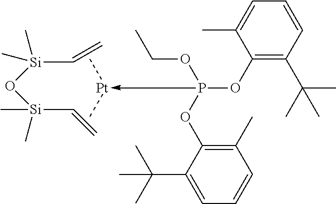

{η⁴—(H₂C═CHSiMe₂)₂O}{Bis(2-tert-butyl-6-methyl-phenyl) ethyl phosphite}platinum was prepared according to the same method as in Catalyst Example 3 (see 3.3. Catalyst Example 3.3 below) starting from Karstedt catalyst (Pt₂ (1,1,3,3-tetramethyl-1,3-divinyldisiloxane) 3-20%—commercially available from JM) and bis(2-tert-butyl-6-methyl-phenyl) ethyl phosphite (phosphite example 2.1).

NMR data:

(¹H-NMR (400 MHZ, CDCl₃, 300 K); ³¹P NMR (121.47 MHz, CDCl₃, 300 K))

The NMR-spectra showed signals of the free phosphite and the complex:

| ³¹P | | ¹H | |
|---|---|---|---|
| ppm | pattern | ppm | pattern |
| 135.5 | s | 1.07 | t |
| 115.5 | Pt-sat | 1.42 | s |
| 155.5 | Pt-sat | 2.66 | s |
| | | 3.84 | dq |
| | | 6.98 | T |
| | | 7.03 | dd |
| | | 7.2 | dd |
| | | 2.00-2.20 | m |
| | | 2.30-2.55 | m |
| | | 2.70-2.90 | m |

### 3.2. Catalyst Example 2 (Inventive Catalyst)

### {η⁴—(H₂C═CHSiMe₂)₂O}{bis(2-tert-butyl-6-methyl-phenyl) methyl phosphite}platinum

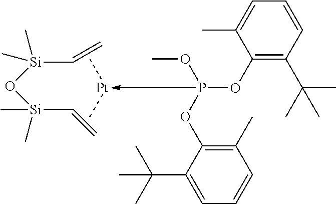

{η⁴—(H₂C═CHSiMe₂)₂O}{Bis(2-tert-butyl-6-methyl-phenyl) methyl phosphite}platinum was prepared according to the same method as in Catalyst Example 3 (see 3.3. Catalyst Example 3.3 below) starting from Karstedt catalyst (Pt₂ (1,1,3,3-tetramethyl-1,3-divinyldisiloxane)₃—20%—commercially available from JM) and bis(2-tert-butyl-6-methyl-phenyl) methyl phosphite (phosphite example 2.2).

NMR data:

(¹H-NMR (400 MHZ, CDCl₃, 300 K); ³¹P NMR (121.47 MHz, CDCl₃, 300 K))

The NMR-spectra showed signals of the free phosphite and the complex:

| ³¹P | | ¹H | |
|---|---|---|---|
| ppm | pattern | ppm | pattern |
| 138.4 | s | 1.43 | s |
| 118.4 | Pt-sat | 2.59 | s |
| 158.4 | Pt-sat | 3.49 | d |
| | | 6.96 | t |
| | | 7.20 | dd |
| | | 7.25 | dd |
| | | 2.00-2.20 | m |
| | | 2.30-2.45 | m |
| | | 2.65-2.85 | m |

### 3.3. Catalyst Example 3 (Comparative Catalyst)

### {η⁴—(H₂C═CHSiMe₂)₂O}{bis(2,4-ditert-butyl-6-methyl-phenyl) ethyl phosphite}platinum

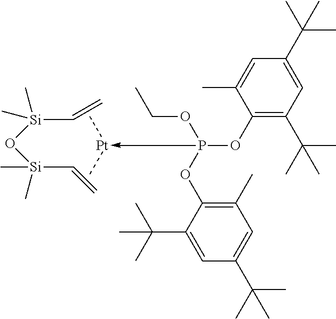

10 g (0.76 mmol platinum) of Karstedt catalyst (Pt₂ (1,1,3,3-tetramethyl-1,3-divinyldisiloxane)₃—20%—commercially available from JM) was dissolved in 20 ml toluene under nitrogen. To this solution 0.40 g of the phosphite of phosphite example 2.3. (bis(2,4-ditert-butyl-6-methyl-phenyl) ethyl phosphite (Irgafos 38)) (96% purity, 0.95 mmol in 10 ml toluene) was added and stirred for 4 h at 60° C. The Karstedt catalyst reacted quantitatively with the phosphite to form the corresponding Pt-Phosphite complex.

NMR data:

(¹H-NMR (400 MHZ, CDCl₃, 300 K); ³¹P NMR (121.47 MHZ, CDCl₃, 300 K))

The NMR-spectra showed signals of the free phosphite and the complex:

| ³¹P | | ¹H | |
|---|---|---|---|
| ppm | pattern | ppm | pattern |
| 135.2 | s | 1.00 | t |
| 115.3 | Pt-sat | 1.28 | s |
| 155.2 | Pt-sat | 1.41 | s |
| | | 2.63 | s |
| | | 3.82 | dq |
| | | 7.01 | d |
| | | 7.20 | d |
| | | 2.11 | m |
| | | 2.41 | m |
| | | 2.87 | m |

### 3.4. Catalyst Example 4 (Inventive Catalyst)

{η⁴—(H₂C═CHSiMe₂)₂O}{ethyl bis(2,4,6-tritert-butylphenyl)phosphite}platinum

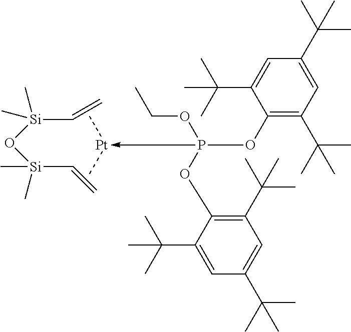

{η⁴—(H₂C═CHSiMe₂)₂O}{ethyl bis(2,4,6-tritert-butylphenyl)phosphite}platinum was prepared according to the same method as in Catalyst Example 3 starting from Karstedt catalyst (Pt₂ (1,1,3,3-tetramethyl-1,3-divinyldisiloxane)₃—20%—commercially available from JM) and ethyl bis(2,4,6-tritert-butylphenyl)phosphite (phosphite example 2.4).

NMR data:

(¹H-NMR (400 MHZ, CDCl₃, 300 K); ³¹P NMR (121.47 MHZ, CDCl₃, 300 K))

The NMR-spectra showed signals of the free phosphite and the complex:

| ³¹P | | ¹H | |
|---|---|---|---|
| ppm | pattern | ppm | pattern |
| 145.9 | s | 0.95 | t |
| 125.8 | Pt-sat | 1.33 | s |
| 166.0 | Pt-sat | 1.41 | s |
| | | 3.49 | dq |
| | | 7.21 | s |
| | | 1.90-2.05 | m |
| | | 2.50-2.70 | m |

(s means singulet, d means doublet, m means multiplet and dq means doublet of quadruplet; sat means satellite peak)

### 3.5. Catalyst Example 5 (Comparative Catalyst)

### Ashby's Catalyst, 15 wt % Pt

It is a Pt (0) complex in tetramethyltetravinylcyclotetrasiloxane and isopropanol of the general formula:

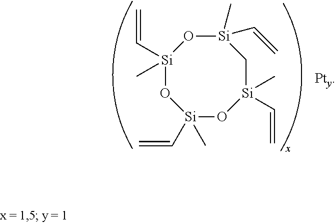

### 3.6. Catalyst Example 6 (Comparative Catalyst)

### {η⁴—(H₂C═CHSiMe₂)₂O}{tris(2,4-ditert-butylphenyl)phosphite}platinum

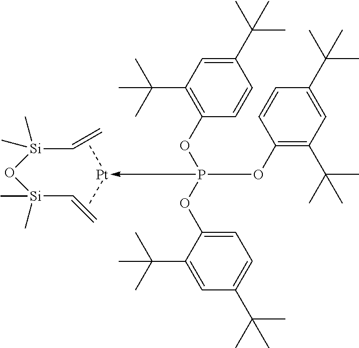

was prepared according to the same method as in Catalyst Example 3 starting from Karstedt catalyst (Pt₂ (1,1,3,3-tetramethyl-1,3-divinyldisiloxane)₃—20%—commercially available from JM) and tris(2,4-ditert-butylphenyl)phosphite (phosphite example 2.5, Irgafos 168).

### 3.7. Catalyst Example 7 (Comparative Catalyst)

### {η⁴—(H₂C═CHSiMe₂)₂O}{tris(2,4-ditert-butyl-5-methyl-phenyl)phosphite}platinum

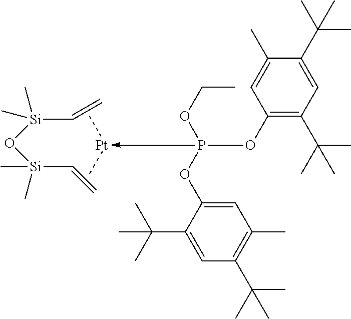

was prepared according to the same method as in Catalyst Example 3 starting from Karstedt catalyst (Pt₂ (1,1,3,3-tetramethyl-1,3-divinyldisiloxane)₃—20%—commercially available from JM) and bis(2,4-ditert-butyl-5-methyl-phenyl) ethyl phosphite (phosphite example 2.6).

### 3.8. Catalyst Example 8 (Comparative Catalyst)

### {η⁴—(H₂C═CHSiMe₂)₂O}{bis(2-allylphenyl) ethyl phosphite}platinum

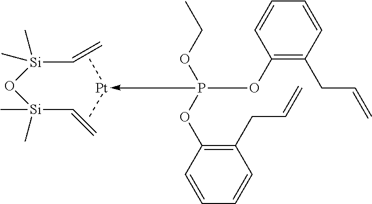

was prepared according to the same method as in Catalyst Example 3 starting from Karstedt catalyst (Pt₂ (1,1,3,3-tetramethyl-1,3-divinyldisiloxane)₃—20%—commercially available from JM) and bis(2-allylphenyl) ethyl phosphite (phosphite example 2.7).

### 3.9. Catalyst Example 9 (Comparative Catalyst)

{η⁴—(H₂C═CHSiMe₂)₂O}{3,9-bis(2,4-ditert-butylphenoxy)-2,4,8,10-tetraoxa-3,9-diphosphaspiro[5.5]undecane}platinum was prepared according to the same method as in Catalyst Example 3 starting from Karstedt catalyst (Pt₂ (1,1,3,3-tetramethyl-1,3-divinyldisiloxane)₃—20%—commercially available from JM) and 3,9-bis(2,4-ditert-butylphenoxy)-2,4,8,10-tetraoxa-3,9-diphosphaspiro[5.5]undecane (phosphite example 2.8).

### C) Manufacture of the Curable Polyorganosiloxane Compositions

### Examples 1-15 and Comparative Examples 1-5

### Manufacture of the Silicone Base Compound

For Examples 1-11 and Comparative Examples 1-5 a silicone base compound consisting of 38 parts of dimethylvinylsilyl-terminated polydimethylsiloxane with an average composition of MVi₂D₅₃₉ having a viscosity of 10 Pa·s and a SiVi content of 0.05 mmol/g, 32 parts of dimethylvinylsilyl-terminated polydimethylsiloxane with an average composition of MVi₂D₈₉₉ having a viscosity of 65 Pa·s and a SiVi content of 0.03 mmol/g, and 30 parts of fumed silica having a Brunauer-Emmett-Teller (BET) specific surface area of 300 m²/g (Aerosil® 300 from Evonik) and being surface treated with hexamethyldisilazane and divinyltetramethyldisilazane with a Vi content of 1.3 wt % was used. The base compound was further mixed with the other components as listed in Tables 1-4 to prepare various silicone rubber formulations. The catalyst was added last when all the other ingredients had been mixed.

The indication of the amount of catalyst using the unit “ppm” refers to the weight of the amount of platinum present in the catalyst applied in relation to the weight of the overall composition.

The indication of the amount of inhibitor using the unit “ppm” refers to the weight of the inhibitor compound applied, i.e. ECH or the compound of phosphite example 2.5, in relation to the weight of the overall composition.

The pot life of the present liquid curable silicone elastomer composition is defined as the time to increase mixed viscosity of the composition to 200% of its initial value, as measured by a plate-plate rheometer at a shear-rate of 10/s, at 25° C. This parameter denotes the minimum processing time.

The curing times of the liquid curable silicone elastomer composition are measured with a Rheometer MDR 2000 of Alpha Technologies using DIN 53529-3. The t90, t60, and t10 times are defined as the times to reach 90%, 60% or 10% of the maximum torque at 100° C.

As shown in table 1 the inventive compositions using the inventive phosphite catalyst have pot lifes of at least 48 h and at the same time retain a curing reactivity corresponding to a t90 of ≤ 2 min.

### Further Detailed Explanations as to the Components Used:

Vinyl siloxane 1: dimethylvinylsiloxy-terminated poly(dimethylsiloxane-co-methylvinylsiloxane) of the average composition MVi₂D₅₆₀DVi₃₆ with a viscosity of 5 Pas at RT (room temperature 25° C.) and at a shear rate of 10 s⁻¹ (according to DIN 53019).

Vinyl siloxane 2: dimethylvinylsilyl-terminated polydimethylsiloxane with an average composition of MVi₂D₅₃₉ and viscosity of 10 Pas at RT.

Vinyl siloxane 3: dimethylvinylsilyl-terminated polydimethylsiloxane with an average composition of MVi₂D₈₉₉ and a viscosity of 65 Pas at RT.

Chain extender 1: hydride terminated poly(dimethylsiloxane) of the average composition MH₂D₁₇ with a viscosity of 20 mPas at RT.

Crosslinker 1: trimethylsilyl-terminated poly(dimethylsiloxane-co-methylhydrogensiloxane) of the average composition M₂D₂₀DH₂₀ having a viscosity of 40 mPas at RT.

Irgafos 168 (see phosphite example 2.5).

Crosslinker 2: resin type with an average composition of MH_{1.7x}Qₓ and a viscosity of 30 mPas at RT.

Crosslinker 3: trimethylsilyl-terminated poly(dimethylsiloxane-co-methylhydrogensiloxane) with an average composition of M₂D₂₀DH₁₀ and a viscosity of 35 mPas at RT.

Crosslinker 4: trimethylsilyl-terminated polymethylhydrogensiloxane with an average composition of M₂DH₃₀ and a viscosity of 15 mPas at RT.

Crosslinker 5: trimethylsilyl-terminated poly(dimethylsiloxane-co-diphenylsiloxane-co-methylhydrogensiloxane) with an average composition of M₂D(Ph₂)₂DH₂₄D₂ and a viscosity of 35 mPas at RT.

Adhesion promoter 1: gamma-methacryloxypropyltrimethoxy silane.

Adhesion promoter 2: gamma-glycidoxypropyltrimethoxy silane.

Adhesion promoter 3: α,2,4,6,6,8-Hexamethylcyclotetrasiloxanepropanoic acid 3-(trimethoxysilyl)propyl ester (CAS 113684-56-3).

Filler 1: Evonik Aerosil R⁸²⁰⁰ silica with a BET surface area of 155 m²/g hydrophobized with HMDZ.

TABLE 1

| Example | | | | | | | | | |
|---|---|---|---|---|---|---|---|---|---|
| Ex. 1 | Ex. 2 | Ex. 3 | Ex. 4 | Comp. 1 | Comp. 2 | Comp. 3 | Comp. 4 | Comp. 5 | Comp. 6 |
| wt % | wt % | wt % | wt % | wt % | wt % | wt % | wt % | wt % | wt % |

Silicone composition

| Base compound | 94.35 | 94.35 | 94.35 | 94.35 | 94.35 | 94.35 | 94.35 | 94.35 | 94.35 | 94.35 |
|---|---|---|---|---|---|---|---|---|---|---|
| Vinyl siloxane 1 | 3.35 | 3.35 | 3.35 | 3.35 | 3.35 | 3.35 | 3.35 | 3.35 | 3.35 | 3.35 |
| Chain extender 1 | 0.7 | 0.7 | 0.7 | 0.7 | 0.7 | 0.7 | 0.7 | 0.7 | 0.7 | 0.7 |
| Crosslinker 1 | 1.6 | 1.6 | 1.6 | 1.6 | 1.6 | 1.6 | 1.6 | 1.6 | 1.6 | 1.6 |
| Catalysts | [ppm] | [ppm] | [ppm] | [ppm] | [ppm] | [ppm] | [ppm] | [ppm] | [ppm] | [ppm] |
| Example 3.1 | 12 | | | | | | | | | |
| Example 3.2 | | 12 | | | | | | | | |
| Example 3.3 (Comparative) | | | 12 | | | | | | | |
| Example 3.4 | | | | 12 | | | | | | |
| Example 3.5 (Comparative) | | | | | 12 | 12 | | | | |
| Example 3.6 (Comparative) | | | | | | | 12 | | | |
| Example 3.7 (Comparative) | | | | | | | | 12 | | |
| Example 3.8 (Comparative) | | | | | | | | | 12 | |
| Example 3.9 (Comparative) | | | | | | | | | | 12 |

Inhibitors

| | | | | | | |
|---|---|---|---|---|---|---|
| 1-Ethinyl-1-cyclohexanol (ECH) | 100 | 100 | 50 | | 100 | 400 |
| Phosphite example 2.5 | | | | 20 | | |

reactivity @ 100° C. [min]

| | | | | | | | | | | |
|---|---|---|---|---|---|---|---|---|---|---|
| t10 | 0.8 | 0.7 | 0.7 | 0.5 | 0.3 | 5.4 | 1.9 | no | no | no |
| t60 | 1.1 | 1.1 | 0.9 | 0.7 | 0.4 | 6.3 | 5.7 | curing* | curing* | curing* |
| t90 | 1.6 | 1.9 | 1.2 | 0.9 | 0.5 | 8.0 | 12.2 | | | |

pot life @ room temperature [h]

| | | | | | | | | | |
|---|---|---|---|---|---|---|---|---|---|
| >72 | >72 | >72 | 48-72 | <24 | >72 | >72 | >72 | >72 | >72 |

*no crosslinking has been detected within 10 min at 100° C.

TABLE 2
(variation of SiH-crosslinkers)

| | | | | |
|---|---|---|---|---|
| | Ex. 5 | Ex. 6 | Ex. 7 | Ex. 8 |
| Example | wt % | wt % | wt % | wt % |

Silicone composition

| | | | | |
|---|---|---|---|---|
| Base compound | 94.65 | 92.85 | 95.15 | 94.85 |
| Vinyl siloxane 1 | 3.35 | 3.35 | 3.35 | 3.35 |
| Chain extender 1 | 0.7 | 0.7 | 0.7 | 0.7 |
| Crosslinker 2 | 1.3 | | | |
| Crosslinker 3 | | 3.1 | | |
| Crosslinker 4 | | | 0.8 | |
| Crosslinker 5 | | | | 1.1 |
| Catalyst | [ppm] | [ppm] | [ppm] | [ppm] |
| Example 3.1 | 12 | 12 | 12 | 12 |
| Inhibitors | | | | |
| 1-Ethinyl-1-cyclohexanol | 100 | 100 | 100 | 100 |
| Phosphite example 2.1. | 70 | | | |

reactivity @ 100° C. [min]

| | | | | |
|---|---|---|---|---|
| t10 | 0.9 | 0.8 | 0.7 | 0.8 |
| t60 | 1.1 | 1.0 | 0.9 | 1.1 |
| t90 | 1.5 | 1.4 | 1.6 | 2.0 |

pot life @ room temperature [h]

| | | | |
|---|---|---|---|
| 48 | >72 | >72 | >72 |

As shown in table 2 (examples 5 to 8) even with varying SiH-crosslinkers the target pot life of at least 48 h and the target reactivity t90 of ≤2 minutes are achieved.

TABLE 3
(effect of adhesion promotors)

| | | | |
|---|---|---|---|
| | Ex. 9 | Ex. 10 | Ex. 11 |
| Example | wt % | wt % | wt % |

Silicone composition

| | | | |
|---|---|---|---|
| Base compound | 93.85 | 93.85 | 94.1 |
| Vinyl siloxane 1 | 3.35 | 3.35 | 3.35 |
| Chain extender 1 | 0.7 | 0.7 | 0.7 |
| Crosslinker 1 | 1.6 | 1.6 | 1.35 |
| Adhesion promoter 1 | 0.5 | | |
| Adhesion promoter 2 | | 0.5 | |
| Adhesion promoter 3 | | | 0.5 |
| Catalyst | [ppm] | [ppm] | [ppm] |
| Example 3.1 | 12 | 12 | 12 |
| Inhibitor | | | |
| 1-Ethinyl-1- | 100 | 100 | 100 |
| cyclohexanol | | | |

reactivity @ 100° C. [min]

| | | | |
|---|---|---|---|
| t10 | 0.5 | 0.8 | 0.8 |
| t60 | 0.7 | 1.1 | 1.1 |
| t90 | 1.0 | 1.6 | 1.9 |

pot life @ room temperature [h]

| | | |
|---|---|---|
| >72 | >72 | >72 |

As shown in table 3 (examples 9 to 11) even with the addition of varying adhesion promotors the target pot life of at least 48 h and the target reactivity 190 of ≤2 minutes are achieved.

TABLE 4
(variation of filler contents)

| | Ex. 12 | Ex. 13 | Ex. 14 | Ex. 15 |
|---|---|---|---|---|
| Example | wt % | wt % | wt % | wt % |
| Silicone composition | | | | |
| Vinyl siloxane 2 | 52.1 | 51.6 | 43.9 | 35.6 |
| Vinyl siloxane 3 | 41.85 | 41.35 | 35.25 | 28.75 |
| Vinyl siloxane 1 | 3.35 | 3.35 | 3.35 | 3.35 |
| Chain extender 1 | 0.7 | 0.7 | 0.7 | 0.7 |
| Crosslinker 1 | 2 | 2 | 1.8 | 1.6 |
| Filler 1 | 0 | 0 | 15 | 30 |
| Adhesion promoter 2 | | 1 | | |
| Catalyst | [ppm] | [ppm] | [ppm] | [ppm] |
| Example 3.1 | 12 | 12 | 12 | 12 |
| Inhibitor | | | | |
| 1-Ethinyl-1-cyclohexanol | 100 | 100 | 100 | 100 |

reactivity @ 100° C. [min]

| | | | | |
|---|---|---|---|---|
| t10 | 0.9 | 0.8 | 1.1 | 0.9 |
| t60 | 1.2 | 1.1 | 1.4 | 1.2 |
| t90 | 1.6 | 1.3 | 1.8 | 1.7 |

pot life @ room temperature [h]

| | | | |
|---|---|---|---|
| >72 | >72 | >72 | >72 |

For examples 12-15 all components listed in Table 4 were mixed to prepare various silicone rubber formulations. The catalyst was added last when all the other ingredients had been mixed.

As shown in table 4 (examples 12 to 15) even with varying filler contents the target pot life of at least 48 h and the target reactivity t90 of ≤2 minutes are achieved.

1. A transition metal compound, comprising at least one phosphite compound of the formula 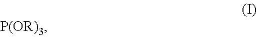
wherein
R represents an organic group, and wherein at least one group R is represented by the formula (II) 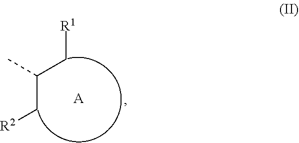
wherein
the ring denoted by A represents an aromatic or heteroaromatic group, which may have one or more further substituents apart from R¹ and R²,
the dotted line represents a single bond to the oxygen atom of the phosphite compound of formula (I),
R¹ and R² each represent substituents in the ortho-position of said aromatic or heteroaromatic group relative to the oxygen atom of the phosphite compound of formula (I), and
wherein said substituents R¹ and R² are each independently selected from the group consisting of an optionally substituted aliphatic group, in particular optionally substituted alkyl groups and optionally substituted alkenyl groups, and an optionally substituted aliphatic bridging group that forms a condensed ring system with another atom of the aromatic or heteroaromatic group corresponding to the ring denoted by A, alkoxy groups, alkoxycarbonyl groups and Si-organic groups,
and wherein at least two groups R are different from each other,
wherein the transition metal of the transition metal compound is selected from the group consisting of nickel, ruthenium, palladium, osmium, indium, and platinum,
with the proviso that the transition metal compound is different from
Pt complexes comprising the phosphite of the formula 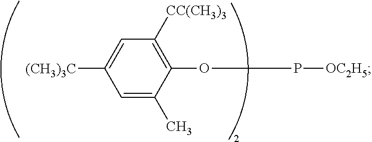
Pd and Pt complexes comprising phosphites of the general formula 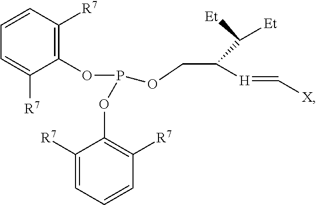
wherein R⁷ is methyl and X is a ferrocenyl group,
or R⁷ is methyl and X is a cymantrenyl group,
or R⁷ is isopropyl and X is a ferrocenyl group.

2. The transition metal compound according to claim 1, comprising at least one phosphite having the formula (III): 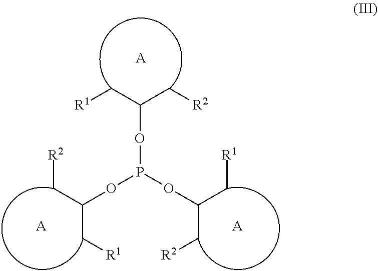
wherein at least two of the groups of the formula (II): 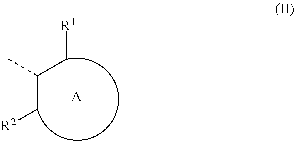
are different groups.

3. The transition metal compound according to claim 1, wherein in formula (I) at least one group R is an organic group different from the group of formula (II).

4. The transition metal compound according to claim 1, comprising at least one phosphite selected from the group consisting of the formulae (IV) or (V): 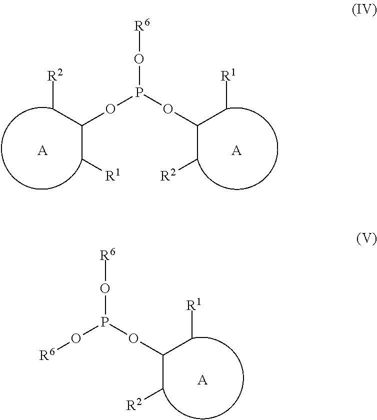
wherein in formula (IV) the groups of the formula (II): 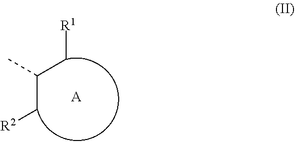
are the same or different groups, and preferably are the same groups, and
are in both formulae (IV) or (V) as defined above, and
wherein the groups R⁶ in formula (V) are the same or different groups, and preferably the groups R⁶ are the same groups, and the groups R⁶ are in both formulae (IV) or (V) selected from organic groups different from those of formula (II), and are preferably selected from optionally substituted aliphatic groups, such as optionally substituted alkyl or optionally substituted cycloalkyl groups.

5. The transition metal compound according to claim 1, wherein the ring denoted by “A” in at least one group represented by formula (II) is an aromatic group, which optionally may have one or more further substituents apart from R¹ and R²,
preferably the ring denoted by “A” in at least one group represented by formula (II) is a phenyl group, which optionally may have one or more further substituents apart from R¹ and R².

6. The transition metal compound according to claim 1, wherein the groups R¹ and R² are each optionally substituted linear, branched or cyclic alkyl groups, preferably having up to 10 carbon atoms, more preferably up to 6 carbon atoms.

7. The transition metal compound according to claim 1, wherein the phosphites of formula (I) are selected from the compounds of formula (VI): 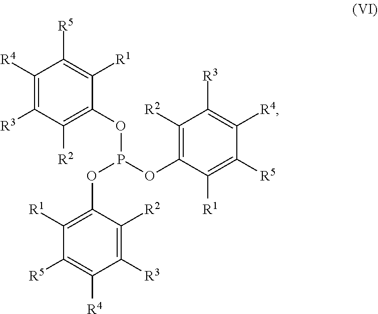
or selected from compounds of the formula (VII), 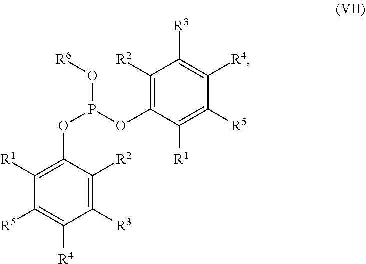
wherein in formulae (VI) and (VII) R¹, R² and R⁶ are each as defined above, and R³, R⁴, and R⁵ are each independently selected from hydrogen, halogen, cyano, nitro, Si-organic and organic groups, preferably optionally substituted aliphatic groups, and wherein in formulae (VI) at least two of the substituent groups: 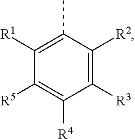
wherein the dotted line represents a single bond to the oxygen atom of the phosphite compound of the formula (I), are different from each other, and wherein in formula (VII) the two substituent groups 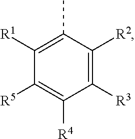
wherein the dotted line represents a single bond to the oxygen atom of the phosphite compound of the formula (I), are preferably the same.

8. The transition metal compound according to any claim 1, wherein the phosphites of formula (I) are selected from

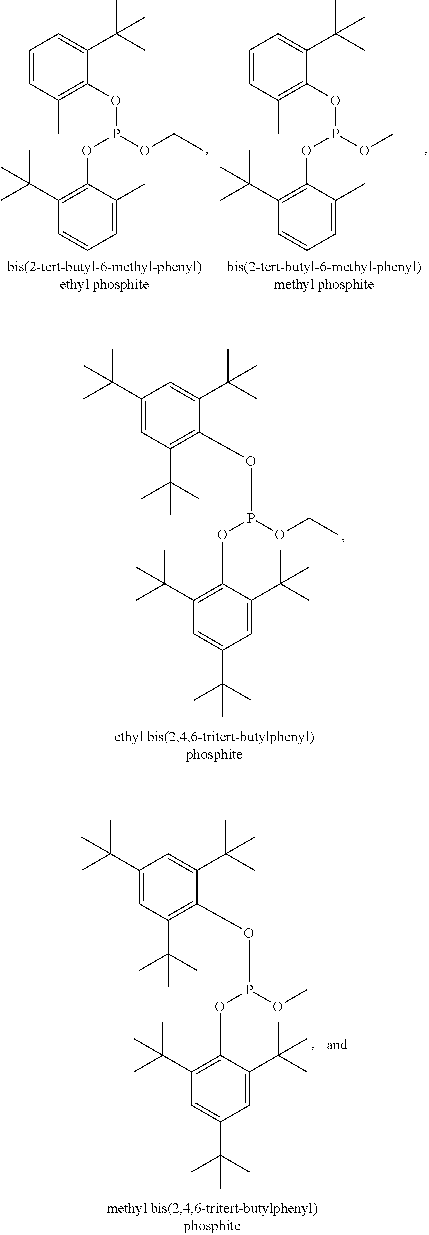

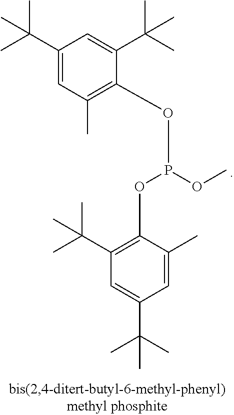 [SMILES: COP(Oc1c(C)cc(C(C)(C)C)cc1C(C)(C)C)Oc1c(C)cc(C(C)(C)C)cc1C(C)(C)C]

9. The transition metal compound according to claim 1,
wherein the transition metal compound is a transition metal complex compound wherein the transition metal has the oxidation state zero (0), preferably the transition metal complex compound is Pt (0)-compound.

10. The transition metal compound according to claim 1, comprising one or more alkenyl ligands, preferably comprising one or more alkenyl siloxane ligands, more preferably a transition metal compound of the formula: 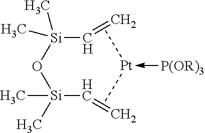
wherein P(OR)₃ is a phosphite of formula (I) as defined above.

11. A curable polyorganosiloxane composition and/or silane composition, comprising:
(A) one or more polyorganosiloxanes and/or silanes having in average at least two alkenyl groups,
(B) one or more polyorganosiloxanes and/or silanes having in average at least two SiH groups,
(C) one or more transition metal compounds comprising a phosphite of the formula (I); P(OR)₃ (I),
wherein in the formula (I)
R represents an organic group, and wherein at least one group R is represented by the formula (II) 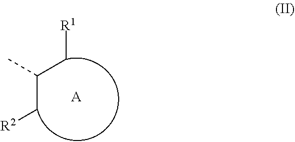
wherein
the ring denoted by A represents an aromatic or heteroaromatic group, which may have one or more further substituents apart from R¹ and R²,
the dotted line represents a single bond to the oxygen atom of the phosphite compound of formula (I),
R¹ and R² each represent substituents in the ortho-position of said aromatic or heteroaromatic group relative to the oxygen atom of the phosphite compound of formula (I), and
wherein said substituents R¹ and R² are each independently selected from the group consisting of an optionally substituted aliphatic group, in particular optionally substituted alkyl groups and optionally substituted alkenyl groups, and an optionally substituted aliphatic bridging group that forms a condensed ring system with another atom of the aromatic or heteroaromatic group corresponding to the ring denoted by A, alkoxy groups, alkoxycarbonyl groups and Si-organic groups,
and wherein at least two groups R are different from each other,
wherein the transition metal is selected from group consisting of nickel, ruthenium, rhodium, palladium, osmium, iridium, and platinum, preferably platinum,
(D) optionally one or more phosphites of the formula (I), and
(E) optionally one or more auxiliary agents.

12. The curable polyorganosiloxane composition and/or silane composition according to claim 11, comprising:
(A) one or more polyorganosiloxanes and/or silanes having in average at least two alkenyl groups,
(B) one or more polyorganosiloxanes and/or silanes having in average at least two SiH groups,
(C) one or more transition metal compounds comprising a phosphite of the formula (I), wherein the transition metal is selected from group consisting of nickel, ruthenium, rhodium, palladium, osmium, iridium, and platinum,
(D) optionally one or more phosphites of the formula (I) as defined above, and
(E) optionally one or more auxiliary agents,
wherein the composition comprises:
100 pw of component (A),
0.1-200 pw of component (B)
0.1-1000 ppm of the transition metal contained in component (C) related to (A) and (B),
0.0 to 12000 ppm of component (D) related to (A) and (B),
0 to 200 pw of component (E),
and wherein preferably
the molar ratio of platinum to the one or more phosphites of formula (I) is from 1:1 to 1:10.

13. A two-part curable polyorganosiloxane and/or silane compositions, comprising one or more phosphites of the formula (I) as defined in claim 1.

14. A method of forming a cured material comprising curing the curable polyorganosiloxane compositions and/or silane compositions of claim 11.

15. A process for the manufacture of the curable polyorganosiloxane compositions as defined in claim 1, comprising mixing
(A) one or more polyorganosiloxanes and/or silanes having in average at least two alkenyl groups,
(B) one or more polyorganosiloxanes and/or silanes having in average at least two SiH groups,
(C) one or more transition metal compounds, wherein the transition metal is selected from group consisting of nickel, ruthenium, rhodium, palladium, osmium, iridium, and platinum,
(D) optionally one or more phosphites of the formula (I), and
(E) optionally one or more auxiliary agents
in a mixing apparatus.

16. A cured polyorganosiloxane and/or silane compositions obtained by curing the curable polyorganosiloxane and/or silane compositions as defined in claim 11.

17. The method of claim 14, wherein the cured material is formed as a shaped formed article, an extruded article, a coatings, or a sealant.

18. A method of curing a curable polyorganosiloxane composition and/or a silane composition comprising curing the curable polyorganosiloxane composition and/or the silane composition in the presence of a transition metal compound comprising a phosphite of the formula (I): 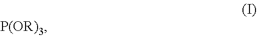
as a curing catalyst for curable polyorganosiloxane compositions and/or silane compositions, wherein in the formula (I)
R represents an organic group, and wherein at least one group R is represented by the formula (II) 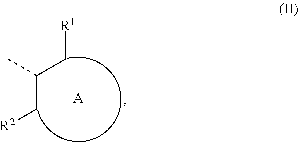
wherein
the ring denoted by A represents an aromatic or heteroaromatic group, which may have one or more further substituents apart from R¹ and R²,
the dotted line represents a single bond to the oxygen atom of the phosphite compound of formula (I),
R¹ and R² each represent substituents in the ortho-position of said aromatic or heteroaromatic group relative to the oxygen atom of the phosphite compound of formula (I), and
wherein said substituents R¹ and R² are each independently selected from the group consisting of an optionally substituted aliphatic group, in particular optionally substituted alkyl groups and optionally substituted alkenyl groups, and an optionally substituted aliphatic bridging group that forms a condensed ring system with another atom of the aromatic or heteroaromatic group corresponding to the ring denoted by A, alkoxy groups, alkoxycarbonyl groups and Si-organic groups,
and wherein at least two groups R are different from each other.

19. The method of claim 18, wherein the transition metal compound is added to the curable polyorganosiloxane composition and/or the silane composition as a pre-formed compound.

20. The method of claim 18, wherein the transition metal compound is formed in situ in the curable polyorganosiloxane composition and/or the silane composition from a transition metal precursor compound and the phosphite of the formula (I).

21. The curable polyorganosiloxane composition and/or silane composition of claim 11, wherein the transition metal compound comprising a phosphite of the formula (I) is (i) an isolated compound, or (ii) preformed by mixing a transition metal-containing precursor compound and one or more of the phosphites of the formula (I)
